(19) United States
(12) Patent Application Publication
(10) Pub. No.: US 2008/0172627 A1
(43) Pub. Date: Jul. 17, 2008

(54) INFORMATION DISPLAY APPARATUS, INFORMATION PROVIDING SERVER, INFORMATION DISPLAY SYSTEM, METHOD FOR CONTROLLING INFORMATION DISPLAY APPARATUS, METHOD FOR CONTROLLING INFORMATION PROVIDING SERVER, CONTROL PROGRAM AND RECORDING MEDIUM

(75) Inventors: Toshihide Hagawa, Chiba-shi (JP); Soichi Nitta, Narashino-shi (JP); Masanao Ohashi, Tenri-shi (JP); Kiyotaka Kashito, Tenri-shi (JP); Masahiro Chiba, Nara-shi (JP); Masafumi Hirata, Tokyo (JP); Aya Enatsu, Chiba-shi (JP); Ken Inamoto, Tondabayashi-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 11/965,672

(22) Filed: Dec. 27, 2007

Related U.S. Application Data
(60) Provisional application No. 60/882,396, filed on Dec. 28, 2006.

(51) Int. Cl. G06F 3/048

(52) U.S. Cl. 715/765

(57) ABSTRACT

A digital television of the present invention includes an object information storage section and a key assignment control section. The object information storage section contains one or more numerical attribute values indicative of an attribute(s) of each object in association with the object. The key assignment control section ranks the objects by the one or more attribute values in accordance with a predetermined rule and assigns the objects to the direction keys sequentially as they are ranked. As a result, the user can efficiently select a target object and enjoy improved user operability.

The present application claims the benefit under 35 USC §119(e) of U.S. Provisional Patent Application Ser. No. 60/882,396, filed on 28, Dec. 2006. The present application is based on and claims priority from this application, the disclosure of which is hereby expressly incorporated herein by reference in its entirety.

### FIELD OF THE INVENTION

The present invention relates to information display apparatuses, information providing servers, information display systems, control methods for the information display apparatuses, control methods for information providing servers, control programs, and recording media for displaying two or more pieces of information (objects) for selection by a user.

### BACKGROUND OF THE INVENTION

Information display apparatuses very often display on it two or more pieces of information (objects) in such a manner that a user can choose from the pieces of information using an input device. In cases where the information display apparatus is, for example, a television or a mobile phone, the input device is provided in the form of a remote controller for manipulating the television or integrated as part of the compact mobile phone itself. The input device for the television and mobile phone can offer an extremely limited number and kinds of keys when compared to the keyboard and mouse for the personal computer.

With these structural restrictions of the input device, conventional efforts have still been made to allow easy on-screen selection of an object and to improve user operability of the information display apparatus.

Japanese Unexamined Patent Publication (Tokukai) 2001-175390 (published Jun. 29, 2001) discloses a technique of selecting from objects irregularly arranged on the screen using a cross key or a like manipulation key with which the user can indicate a limited number of directions, by selecting a destination (object) from positional relationship prior to an input through the manipulation key.

Japanese Unexamined Patent Publication (Tokukai) 2006-246019 (published Sep. 14, 2006) discloses a technique of dynamic manipulation assigning, for each screen layout of two or more displayed screens, of a multi-direction key on the remote controller to screens (objects) displayed on the layout, the assigning being implemented each time the screen layout or the screen control method changes.

Japanese Unexamined Patent Publication (Tokukai) 2005-275859 (published Oct. 6, 2005) discloses a technique of recording object-designating rules in association with direction-indicating keys and when a direction key is pressed, deducing the selected object based on the rules.

Japanese Unexamined Patent Publication (Tokukai) 2005-229361 (published Aug. 25, 2005) discloses a technique of selecting, using a cross key, only those programs which belong to the same category as a reference program from the programs (objects) shown in an electronic program guide.

These conventional techniques do not consider the fact that the number, types, etc. of objects displayed on the display device can be numerous for the following reasons.

Recent dramatic improvements on the performance (ex. resolution) of digital TVs and other information display apparatuses, as well as the growing size of the screen, have made it possible to display many objects simultaneously.

On top of that, the current models of digital TV do not only receive program broadcast; they incorporate a lot of other functions. An example worth mentioning here is communications capability which enables the TV, like the personal computer, to get various information over the Internet and other communications networks.

Hence, the information display apparatus is increasingly capable of displaying a large variety of numerous objects on a huge screen. Meanwhile, the remote controller, with harsh structural restrictions, is still a popular choice of input device. Technology for such input devices is needed which enables the user to easily select from the objects for improved user operability.

The conventional techniques briefly mentioned above force the user to go through very complicated manipulation in order to select a target object from a lot of objects offered by the information display apparatus using an input device with inherent structural restrictions. That gives rise to problems of poor user operability.

### SUMMARY OF THE INVENTION

The present invention, conceived in view of the problems, has an objective of realizing an information display apparatus, an information providing server, an information display system, a method for controlling an information display apparatus, a method for controlling an information providing server, a control program, and a recording medium, for displaying a plurality of objects for selection by a user in such a manner that the user can efficiently select a target object for improved user operability.

An information display apparatus (digital television 1) in accordance with the present invention, to attain the objective, is characterized in that it is an information display apparatus for displaying on a display section a plurality of objects from which a user can select one of the objects by manipulating one or more direction keys so as to instruct a cursor to move in a specified direction and point to that object to be selected, that the apparatus includes an object information storage section containing one or more numerical attribute values indicative of an attributers) of each object in association with that object, and that the apparatus includes: a ranking section (key assignment control section 23) for ranking the objects by the one or more attribute values in accordance with a predetermined rule; and a key assignment section (key assignment control section 23) for assigning the objects to the direction keys sequentially as ranked by the ranking section.

According to the configuration, first, the object information storage section contains objects for display on the display section. Each object has, in association with it, an attribute value which is derived by quantification of an attribute of the object. Each object may be associated with two or more attribute values if the object has more than one attribute.

The ranking section ranks the objects by the one or more attribute values in accordance with a predetermined rule. The predetermined rule defines, in a selection of objects by manipulating the direction keys, which object is to be assigned to a manipulation of which direction key and how to determine an order of assigning objects a direction key.

The ranking section sorts the attribute values out in a certain order (for example, in descending order of attribute value) in accordance with a rule to rank the associated objects. The ranking per se, determined by the ranking section in this manner, represents the order of the objects being selected in response to manipulations of the direction keys (assignment order).

In other words, the key assignment section assigns the objects to the direction keys sequentially as ranked by the ranking section.

Accordingly, the order of the objects being selected in response to manipulations of the direction keys (assignment order) is determined based on a certain order of attribute values. The objects are selected in that order.

From the description above, if any of the direction keys is manipulated, a key assignment can be carried out, considering attributes of the objects, so that the objects are selected in a predetermined order of the attribute values of an attribute. As a result, the user can efficiently select a target object and enjoy improved user operability.

For example, according to one conventional method, objects which could be selected next are assigned to four direction keys, UP, DOWN, LEFT, and RIGHT, on the basis of the reference object currently being selected and the relative positions of the objects to be selected next. However, the user cannot efficiently reach a target object relying solely on the relative positions. The more objects are present between the reference object and the target object, the more manipulations of the direction keys are required until the user can select the target object, which makes user operation troublesome.

According to the configuration, for example, the ranking section uses importance (attribute value) and ranks the objects in descending order of the importance in accordance with a rule. Therefore, the key assignment section assigns the objects to the direction keys in descending order of the importance.

Accordingly, as a direction key is manipulated, objects are selected sequentially in descending order of the importance. A high importance indicates that the object has important information and is likely to be selected by the user. Hence, when a direction key is manipulated, objects which are more likely to be selected by the user are selected before other objects. As a result, the user can efficiently select the target object and enjoy improved user operability.

An information providing server of the invention (a map service providing server 2 and an album managing server 3), to attain the objective, is characterized in that it is an information providing server for supplying, to an information display apparatus, display data used to display on a display section a plurality of objects from which a user can select one of the objects by manipulating one or more direction keys so as to instruct a cursor to move in a specified direction and point to that object to be selected, said server including an object information storage section containing one or more numerical attribute values indicative of an attributers) of each object in association with that object, said server comprising: ranking section for ranking the objects by the one or more attribute values in accordance with a predetermined rule; key assignment section for assigning the objects to the direction keys on the information display apparatus sequentially as ranked by the ranking section; information generating section (key assignment control section 23) for generating association information indicative of correspondence between the objects and the direction keys in accordance with results of the assigning by the key assignment section; and a supplying section (transmitter section 62) for supplying the association information to the information display apparatus.

Another information display apparatus of the invention, to attain the objective, is characterized in that it includes: an information retrieval section (information retrieval section 20) for retrieving display data and association information, the display data being used to display on a display section a plurality of objects from which a user can select one of the objects by manipulating one or more direction keys so as to instruct a cursor to move in a specified direction and point to that object to be selected, the association information being indicative of correspondence between the objects and the direction keys; and an object selecting section (cursor control section 24) for, when one of the direction keys is manipulated while the objects are being displayed on the display section in accordance with the display data, moving the cursor to an object assigned to the manipulated key in accordance with the association information so as to select that object.

An information display system of the invention, to attain the objective, is characterized in that it includes: the information providing server and the information display apparatus.

According to the configuration, the information providing server executes the object extraction and key assigning. Specifically, only the information providing server needs to include the ranking section, the key assignment section, and the extraction section (object extraction section 21).

Accordingly, an information display system can be built which allows simplification of the structure of the information display apparatus as a client and which nonetheless produces similar effects to the embodiment which will be detailed later. The configuration is particularly effective in a system where a single information provider device provides information on objects that should be displayed to many information display apparatuses because the configuration allows simplification of the structure of those many information display apparatuses.

A method for controlling an information display apparatus of the invention, to attain the objective, is characterized in that it is a method for controlling an information display apparatus for displaying on a display section a plurality of objects from which a user can select one of the objects by manipulating one or more direction keys so as to instruct a cursor to move in a specified direction and point to that object to be selected, said method comprising the steps of: (a) ranking, in accordance with a predetermined rule, the objects by one or more numerical attribute values, contained in an object information storage section, indicative of an attributers) of each object in association with that object; and (b) assigning the objects to the direction keys sequentially as ranked in step (a).

A method for controlling an information providing server of the invention, to attain the objective, is characterized in that it is a method for controlling an information providing server for supplying, to an information display apparatus, display data used to display on a display section a plurality of objects from which a user can select one of the objects by manipulating one or more direction keys so as to instruct a cursor to move in a specified direction and point to that object to be selected, said method comprising the steps of: (a) ranking, in accordance with a predetermined rule, the objects by one or more numerical attribute values, contained in an object information storage section, indicative of an attribute(s) of each object in association with that object; (b) assigning the objects to the direction keys on the information display apparatus sequentially as ranked in step (a); (c) generating association information indicative of correspondence between the objects and the direction keys in accordance with results of the assigning in step (b); and (d) supplying the association information to the information display apparatus.

A method for controlling an information display apparatus of the invention, to attain the objective, is characterized in that it involves the steps of: (a) retrieving display data and association information, the display data being used to display on a display section a plurality of objects from which a user can select one of the objects by manipulating one or more direction keys so as to instruct a cursor to move in a specified direction and point to that object to be selected, the association information being indicative of correspondence between the objects and the direction keys; and (b) when one of the direction keys is manipulated while the objects are being displayed on the display section in accordance with the display data, moving the cursor to an object assigned to the manipulated key in accordance with the association information so as to select that object.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating the configuration of a major part of a digital television in accordance with an embodiment of the present invention.

FIG. 2 is a block diagram schematically illustrating the configuration of a digital television in accordance with an embodiment of the present invention.

FIG. 3 is an illustration of an exemplary front view of a manipulation section in the form of a remote controller.

FIG. 4 is an exemplary screen display of an embodiment of the present invention, where a display section displays map data and locale information.

FIG. 5 is a table of exemplary attribute information for objects obtained by an information retrieval section in a digital television of the embodiment.

FIG. 6 is a table of an exemplary set of extraction rules stored in a extraction rule storage section of a digital television of the embodiment.

FIG. 7 is an exemplary conventional display of map data and locale information.

FIG. 8 is a table of an exemplary set of assignment rules stored in an assignment rule storage section of a digital television of the embodiment.

FIG. 9 is a flow chart illustrating an object extraction process and a key assigning process being executed by a digital television.

FIG. 10 is a graph representing importance vs. object counts derived by a statistical processing section of a digital television of the embodiment.

FIG. 11 is a table of exemplary results of statistical processing calculated by a statistical processing section and stored in a statistical result storage section of a digital television of the embodiment.

FIG. 12 is a graph representing importance vs. object counts derived by a statistical processing section of a digital television of the embodiment.

FIG. 13 is an exemplary GUI display generated by an image processing section of a digital television of the embodiment, allowing a user to select a threshold.

FIG. 14 is an exemplary display of two groups of objects (grouping) produced by a display section.

FIG. 15 is an exemplary display of two groups of objects (grouping) produced by a display section.

FIG. 16 is a table of another exemplary set of assignment rules stored in an assignment rule storage section of a digital television of the embodiment.

FIG. 17 is an exemplary display of a guide produced by an image processing section 22 of a digital television of the embodiment.

FIG. 18 is an exemplary display after the second operation by a user.

FIG. 19 is a diagram illustrating direction keys and their assigned actions in a polar coordinate UI.

FIG. 20(a) is a diagram illustrating data structures of information representing an assignment order of objects (locale information) determined by a key assignment control section and stored in an assignment order storage section.

FIG. 20(b) is a diagram illustrating data structures of information representing an assignment order of objects (locale information) determined by a key assignment control section and stored in an assignment order storage section.

FIG. 20(c) is a diagram illustrating data structures of information representing an assignment order of objects (locale information) determined by a key assignment control section and stored in an assignment order storage section.

FIG. 21 is a diagram showing a data structure of an assignment order generated by a key assignment control section.

FIG. 22 is a diagram showing a data structure of an assignment order generated by a key assignment control section.

FIG. 23 is an exemplary random thumbnail display of a plurality of photographs on a display section of a digital television in accordance with the present invention.

FIG. 24 is a diagram illustrating the configuration of major parts of devices in an information display system 100 of an embodiment of the present invention.

### DESCRIPTION OF THE EMBODIMENTS

### Embodiment 1

The following will describe an embodiment of the present invention in reference to figures, in which the information display apparatus of the present invention is assumed to be applied to a digital television that receives terrestrial digital broadcast from broadcasting stations of programs. The assumption, however, is by no means limiting the information display apparatus of the present invention: the apparatus is applicable to any information display apparatus with a display device producing a user interface where objects, along with various information on the objects, are displayed so that a user can select from them using an input device.

### Brief Description of Digital Television

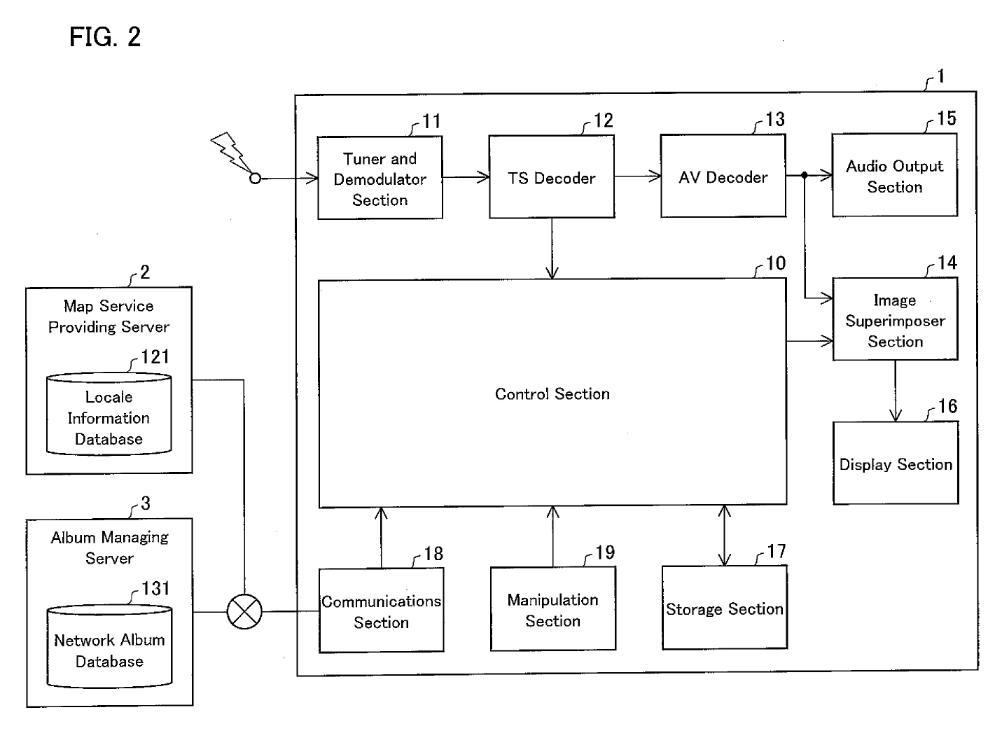

FIG. 2 is a block diagram schematically illustrating the configuration of a digital television 1 of the present embodiment.

Referring to FIG. 2, the digital television 1 of the present embodiment includes a control section 10, a digital broadcast tuner and demodulator section 11, a TS (transport stream) decoder 12, an AV (audio visual) decoder 13, an image superimposer section 14, an audio output section 15, a display section 16, a storage section 17, a communications section 18, and a manipulation section 19.

The control section 10 performs overall control over various operations of components of the digital television 1. The control section 10 will be further described later in terms of its functions.

The digital broadcast tuner and demodulator section 11 performs channel selection on digital broadcast signals received via an antenna from broadcasting stations (not shown) of programs. The section 11 then demodulates signals and corrects errors in accordance with a signal format to produce multiplex digital data. The tuner and demodulator section 11 outputs the multiplex digital data to the TS decoder 12.

The TS decoder 12 decodes the multiplex digital data output of the tuner and demodulator section 11, derives a TS (transport stream), and divides the TS into TS packets according to their usages. The resultant TS packets are transferred to either the AV decoder 13 or the control section 10 depending on the usages of the packets. A TS refers to a stream of signals carrying a continuum of TS packets of fixed length. Apart from video and audio signals, each TS packet can contain data signals of, for example, program information and other necessary information to make a channel selection. The TS decoder 12 divides the derived TS into the TS packets containing video and audio signals (broadcast data) destined for the AV decoder 13 and the TS packets containing various information signals (information data) destined for the control section 10.

The AV decoder 13 decodes the TS packets (broadcast data) fed from the TS decoder 12 to divide the packets into an audio signal and a video signal. The AV decoder 13 outputs the decoded video signal to the image superimposer section 14 and the decoded audio signal to the audio output section 15.

The image superimposer section 14 superimposes the image data generated within the digital television 1 onto the video signal decoded by the AV decoder 13 to generate screen data based on which a display is produced on the display section 16. The generated screen data is output to the display section 16. This configuration enables an overlapping, simultaneous display of video derived from the broadcast data and images, for example, an electronic program guide (EPG), downloaded map information, and photographs from a network album.

The audio output section 15 produces an audio output from the audio signal for the digital television 1. The section 15 is, for example, a speaker.

The display section 16 is a display device, producing an video and/or image display from the video data and/or image data for the digital television 1. The section 16 is, for example, an LCD (liquid crystal display), a PDP (plasma display panel), or a CRT (cathode-ray tube).

The storage section 17 stores control programs and an operation system executed by the control section 10 and various data for retrieval by the control section 10. That data is retrieved during the execution of object extraction whereby objects are extracted for display on the display section 16 and object key assigning whereby each selection object is associated with a press of a particular one of direction keys on the manipulation section 19, both processes performed in accordance with the present invention. The storage section 17 is a nonvolatile storage device.

Preferred examples of the storage device serving as the storage section 17 include disc-shaped recording media, such as DVDs (digital video discs) and hard disks, and semiconductor memories, such as flash memories.

The communications section 18 transmits/receives information to/from external communications devices including a map service providing server 2 and an album managing server 3 over the Internet or other communications networks. The communications section 18, for example, transmits a request message for information on a desired area to the map service providing server 2 and receives detailed information on the desired locale stored in a locale information database (DB) 121 from the map service providing server 2. The detailed information on the locale is, for example, further information on facilities, buildings, shops, and transport and road and traffic information. This kind of detailed information on a locale will be referred to as locale information in the following. Alternatively, the section 18 communicates with the album managing server 3 for an access to a network album DB131 to download photographs from the network album DB131 or upload photographs from the digital television 1.

The manipulation section 19 is an input device enabling the user to enter signals with which to manipulate the digital television 1. In the present embodiment, the manipulation section 19 is assumed, as an example, to be a remote controller, enabling the user to remotely manipulate the digital television 1.

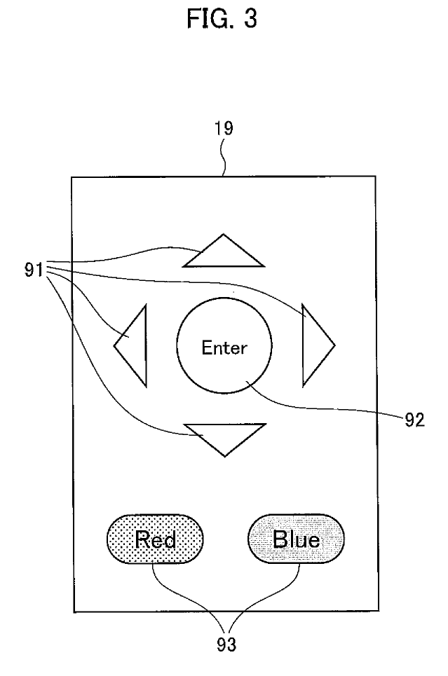

FIG. 3 is an illustration of an exemplary front view of the manipulation section 19 in the form of a remote controller. As shown in FIG. 3, the manipulation section 19 has direction keys 91, an enter key 92, or color keys 93. The direction keys 91 correspond to the up, down, right, and left directions respectively, enabling the user at the transmitting end (remote controller end) to move the cursor which appearing on the display section 16. The enter key 92 enables the user to enter an command. The color keys 93 (a red key and a blue key in FIG. 3) enable the user to switch between various functions and call up special functions of the digital television 1.

The key layout on the manipulation section 19 is by no means limited this particular example. The section 19, as a remote controller with which to manipulate the digital television 1, may have keys with various functions: for example, numeric keys for channel selection, an UP button and a DOWN button for channel and volume increment/decrement, and an ON/OFF button to turn on/off power supply.

The digital television 1 includes a light receiving section (not shown) for receiving, at the receiving end (light receiving section end), command signals (ex. infrared signals) generated by key manipulation at the remote controller end. The command signals received by the light receiving section are fed to an input/output control section (not shown) in the control section 10.

The command signal inputs from the user to the digital television 1 via the manipulation section 19 are received by the input/output control section in the control section 10 and fed to various components of the control section 10. Examples of the signals include a command to display a particular piece of information and a command to select one of objects being displayed on the display section 16.

Next will be described the functions of components of the control section 10 in the digital television 1 of the present embodiment.

### Map Display Function

In the following, an example is taken for descriptive purposes where the digital television 1 executes a function to display a map transferred from the map service providing server 2 shown in FIG. 2.

Specifically, the map service provided by the map service providing server 2 is to supply a client (in this example, digital television 1) with map image data (or satellite photograph data) and detailed locale information given in advance to predetermined locales in the map.

The map service providing server 2 identifies the map data that matches the area requested by the digital television 1 and extracts locale information for the locales which are included in the map data from the locale information stored in association with each locale in the locale information DB121. The server 2 then sends the map data and the resultant locale information to the digital television 1.

The digital television 1 produces a display on the display section 16 from the map data and the locale information received from the map service providing server 2.

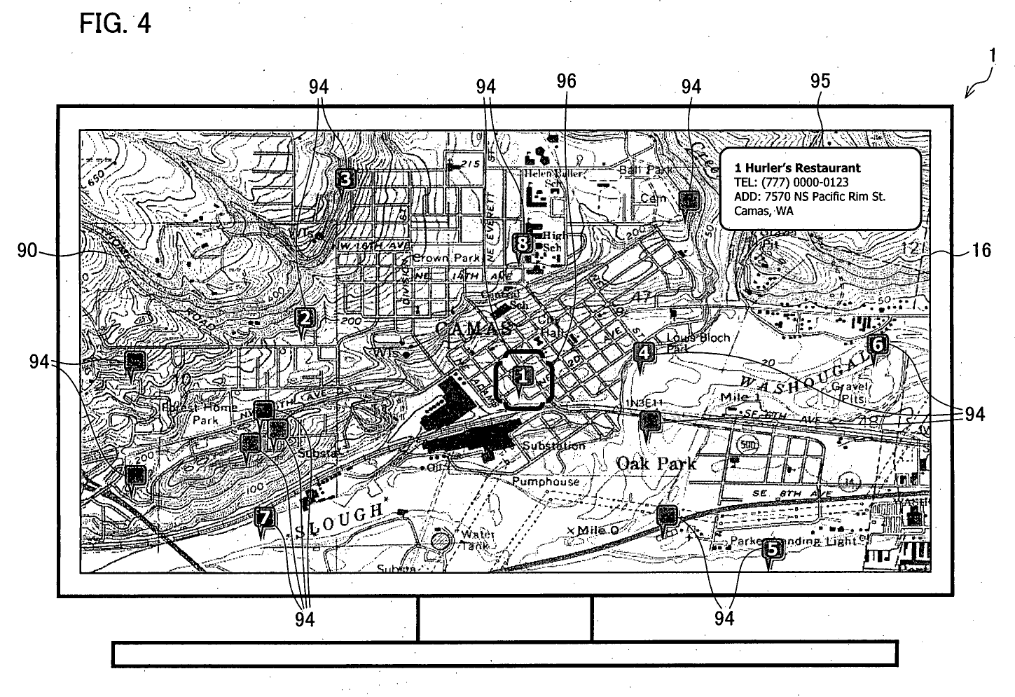

FIG. 4 shows an exemplary screen display of the map and the locale information on the display section 16. In the present embodiment, the digital television 1 shows balloons (objects) 94 on map data 90 as shown in FIG. 4. Each balloon indicates a locale which has locale information available. The position of a balloon 94 is calculated from a latitude and longitude contained in the locale information. The superimposing of the map data 90 and the balloons 94 may be carried out by the digital television 1 or by the map service providing server 2. The user can select the balloon 94 of any locale using the direction keys 91 shown in FIG. 3. Then, locale information 95 for the locale indicated by the balloon (selection object) being selected is displayed. A cursor 96 is displayed around the balloon being selected so that the user can easily recognize that the balloon is being selected (selection object).

### Detailed Description of Digital Television

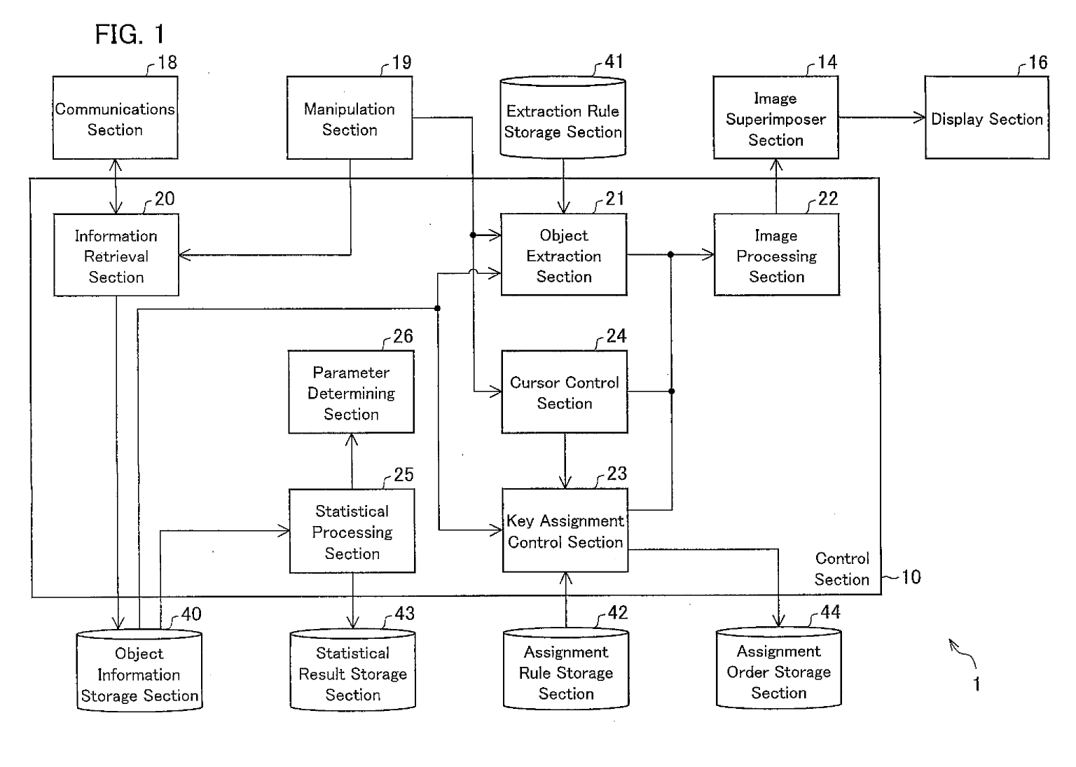

FIG. 1 is a block diagram illustrating the configuration of a major part of the digital television 1 of the present embodiment.

The control section 10 includes functional blocks: namely, an information retrieval section 20, an object extraction section 21, an image processing section 22, a key assignment control section 23, and a cursor control section 24. The section 10 may further include a statistical processing section 25 and a parameter determining section 26. The sections identified as functional blocks are realized by a CPU (central processing unit) executing computer programs loaded from a ROM (read only memory) or other storage device to a RAM (random access memory) or like memory (not shown). The information retrieval section 20, the object extraction section 21, the image processing section 22, the key assignment control section 23, the cursor control section 24, the statistical processing section 25, and the parameter determining section 26 are functional blocks realized by the CPU executing the computer programs stored in the storage device and controlling periphery circuitry, such as input/output circuits (not shown).

The information retrieval section 20 acquires objects that should be displayed and attribute information of those objects from an external storage device in accordance with a signal for an information display command fed from the manipulation section 19. The attribute information of an object is information indicating an attribute of the object, the attribute being given in association with the object.

Specifically, in the present embodiment, the information retrieval section 20, upon receiving a command to display a map for an area from the manipulation section 19, sends a request message for the area map to the map service providing server 2 via the communications section 18. The information retrieval section 20 then obtains map data and locale information (attribute information) for locales (objects) displayed in the map data as balloons 94 from the map service providing server 2 via the communications section 18. The locale information obtained is stored to an object information storage section 40 in association with the map data obtained.

The message transmitted from the information retrieval section 20 to the map service providing server 2 contains a central latitude (for example, N 45.59.03.143), a central longitude (W 122.32.30.256), and scale (for example, 1/25000). Using this information, the map service providing server 2 identifies which map data should be sent to the digital television 1.

The information retrieval section 20 may obtain the map data and locale information from another external storage device containing the same database, rather than from the map service providing server 2, over, for example, the Internet, a LAN (Local Area Network), or like communications networks and store the map data and locale information in the object information storage section 40.

Alternatively, the section 20 may directly read a recording medium containing the map data and locale information.

The object extraction section 21 identifies objects that should be displayed on the display section 16 in accordance with predetermined extraction rules. In the present embodiment, the object extraction section 21 extracts locale information which will be provided for selection by the user from the locale information which was obtained by the information retrieval section 20 and stored in the object information storage section 40 in accordance with the extraction rules. Accordingly, only those balloons 94 for the locales corresponding to the locale information which was extracted is displayed along with the map data 90 on the display section 16. In the present embodiment, the extraction rule storage section 41 stores a set of extraction rules in advance. The object extraction section 21 extracts suitable objects (locale information) according to one or a combination of the extraction rules stored in the extraction rule storage section 41.

The extraction rules are, for example: Extract objects which were updated after a certain point in time; and extract objects which were viewed more frequently than a certain threshold. The extraction rules specify a extraction method for objects so that the object extraction section 21 does not extract objects relatively unlikely to be requested by the user. Thus, information is displayed by hiding many of the objects that are relatively unlikely to be selected by the user, which helps the user select desired objects.

The image processing section 22 generates an OSD (on screen display) image for output to the image superimposer section 14 (display section 16) shown in FIG. 2. The OSD image is generated from various information contained in the storage section 17: for example, map data, locale information, EPG information, menu screen (GUI) image data for manipulation of the digital television 1. The OSD image generated by the image processing section 22 is output to the image superimposer section 14 and the display section 16. The OSD image in which balloons (locale information) appear in the map data is presented to the user as the locale information as shown in FIG. 4, for example.

The key assignment control section 23 associates the keys on the manipulation section 19 which are pressed to designate selection objects to be selected by the user from a plurality of objects displayed on the display section 16 to selection objects which will be selected by pressing the keys in accordance with a predetermined set of assignment rules. In other words, the section 23 executes an object key assigning process. In the present embodiment, the balloons 94 displayed on the display section 16 and the functions of selecting one of the balloons 94 are assigned to the four direction keys 91 (UP, DOWN, RIGHT, and LEFT) on the manipulation section 19. More specifically, the key assignment control section 23 uses an object being selected at a point in time as a reference and associates the balloons 94 which can be selected next when a direction key 91 is pressed at that point in time to the UP/DOWN/LEFT/RIGHT keys.

Accordingly, if one of the direction keys 91 is pressed at the point in time, the selection object is switched from the reference object (balloon 94) to the next object (balloon 94) associated with that key (the cursor 96 transitions).

In the present embodiment, the assignment rule storage section 42 stores a set of assignment rules in advance. The key assignment control section 23 carries out suitable key assigning according to one or a combination of the assignment rules stored in the assignment rule storage section 42.

The assignment rules are, for example: Select an object with the UP key in ascending order of importance of information starting from the reference object; and select an object with the RIGHT key in reverse chronological order in terms of last update. In this manner, the rules are designed to assign objects to keys in descending order of likelihood of the objects being selected by the user. The key assignment control section 23 ranks the objects according to the assignment rules and determines the assignment order in which objects are assigned to the keys. Accordingly, the keys are assigned so that objects are selected in descending order of likelihood of the objects being wanted by the user.

The key assignment control section 23 may determine the descending order of likelihood of objects being selected by the user by the following method as an example. Specifically, the key assignment control section 23 ranks objects in either descending or ascending order of the attribute information of the objects (evaluated in terms of numerical values, “attribute values”) in accordance with the assignment rules. For example, if the attribute value is importance, the key assignment control section 23 ranks the objects in descending order of numerical representation of importance and assigns the objects to the direction keys in that order.

When that is the case, regarding the direction keys, if a direction key is pressed, objects are selected in descending order of the importance. An object with high importance contains important information and is more likely to be selected by the user for that reason.

In this way, the key assignment control section 23 is capable of carrying out key assigning so that objects are selected in descending order of likelihood of the objects being selected by the user.

Alternatively, the assignment order may be determined in accordance with rules specified considering the relative positions of the reference object and candidates for the selection object which will be selected next and the directions of the direction keys. For example, objects located in the directions indicated by the direction keys are selected in increasing order of distance from the reference object. Accordingly, the key assignment control section 23 can carry out a key assignment so that objects are selected in an order that is intuitively understandable to the user.

Alternatively, the key assignment control section 23 may carry out a key assignment in accordance with a combination of assignment rules. Accordingly, a user interface is provided which is intuitively understandable to the user and enables easy selection of a target object with relatively few key strokes.

The cursor control section 24 identifies a specified selection object in response to a direction-indicating signal supplied from the direction keys 91 on the manipulation section 19 in accordance with the key assignment by the key assignment control section 23. The cursor control section 24 sends a command to the image processing section 22 so that the cursor 96 is displayed around the identified selection object.

Accordingly, if the user press one of the direction keys 91, another selection object (balloon 94) corresponding to the direction associated by the key assignment control section 23 is identified. The cursor 96 moves to the newly specified balloon 94.

### Attribute Information of Objects

Next will be described attribute information of objects obtained by the information retrieval section 20. The attribute information of an object is information indicating an attribute of the object, the attribute being given in association to the object. In the present embodiment, the information retrieval section 20 obtains map data and locale information for locales displayed in the map data. The locale information associated with the map data is quantified and stored as attribute information (attribute value) for each locale (object) in the object information storage section 40 in the storage section 17. A plurality of attribute values are preferably associated with the objects in accordance with various attributes. This enables more accurate ranking of the objects in descending order of likelihood of the objects being selected by the user.

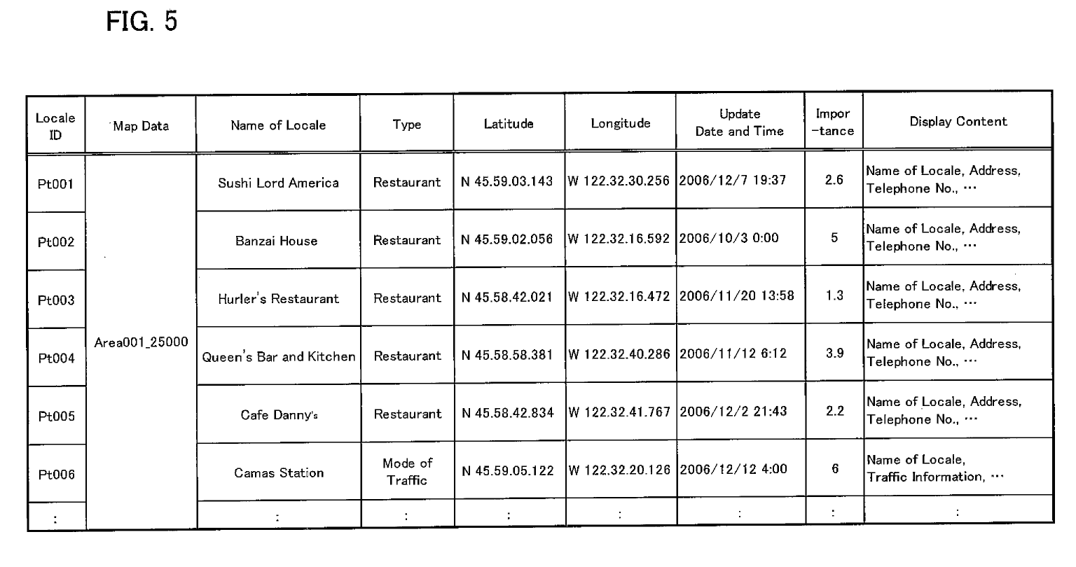

FIG. 5 is a table of exemplary attribute information for objects obtained by the information retrieval section 20. In the present embodiment, the information retrieval section 20 obtains locale information in the form of attribute information of objects. FIG. 5 shows an example of locale information for locales in map data (data name: Area001_{—}25000) supplied together with the map data and stored in tabular format in the object information storage section 40.

As shown in FIG. 5, the locale information is stored for each locale in association with the supplied map data. A name, type, latitude, longitude, update date and time, importance, and display content in the map data are stored in association with a locale ID for each locale.

The name of the locale is the name of a building at the locale or the name of the place. The type is the type of the building or the place. Accordingly, the locales can be divided into groups in managing them: for example, restaurants, theme parks, shops, modes of transport, etc. The latitude and longitude are indices for the physical location of the locale. The locations of the balloons 94 in the map are determined based on the latitude and longitude of the corresponding locales.

The update date and time is the update date and time of the locale information. In the present embodiment, since the locale information is managed single-handedly by the map service providing server 2, the update date and time matches the date and time when the locale information was updated by the map service providing server 2. However, this is by no means intended to be limiting the invention: for example, the update date and time may match the date and time when the digital television 1 downloaded the locale information from the map service providing server 2 for managerial purposes.

The importance is a numerical value indicating how important the locale is and specified in advance on a unique scale by the map service provider who owns the map service providing server 2. The greater the numerical value of the importance, the more important the locale. The importance is set so that a greater numerical value indicates a greater likelihood of the user wanting the information.

Map service providers can allocate any numerical values to the importance of the locales as they like. An example is to give large values to locales which are requested frequently by clients, updated lately, frequented by a large number of customers, attracting a high degree of public attention, and are simply popular because these locales are safely regarded as “important.”

The display content is the content of the locale information for a locale selected by the user and displayed in a frame as locale information 95 as shown in FIG. 4. Referring to FIG. 5, for example, if the type of locale is restaurant, the locale information 95 may show the name, address, and phone number of that locale. Another example is that if the type of locale is mode of transport, the locale information 95 may display traffic information. The content of the locale information is by no means limited to these examples; the area reserved for the locale information 95 may display the latitude, longitude, update date and time, etc. as well as the name, address, and phone number of the locale.

The locale information stored in the object information storage section 40 is referenced by the object extraction section 21 and the key assignment control section 23 in executing the object extraction process and the key assigning process respectively.

### Extraction Rules

Next will be described extraction rules stored in the extraction rule storage section 41 for reference by the object extraction section 21. The extraction rules define methods of extracting objects from the objects stored in the object information storage section 40, so that the object extraction section 21 can extract objects for display on the display section 16 with high priority given to the objects whose information is likely to be wanted by the user or so that the object extraction section 21 does not extract the objects whose information is not very likely or not at all likely to be wanted by the user.

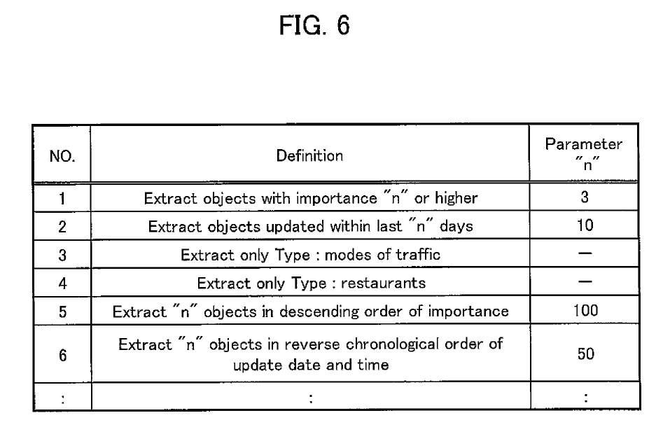

FIG. 6 is a table of an exemplary set of extraction rules stored in the extraction rule storage section 41. As shown in FIG. 6, the extraction rule storage section 41 stores information defining object extraction methods and if necessary, thresholds, a maximum number of extracted objects, and other parameters for each rule.

Extraction rule 1 defines an extraction of objects for display based on the importance of the objects (locale information).

Specifically describing by way of the example in FIG. 5, the object extraction section 21 extracts locale information whose importance is 3 or greater from the locale information stored in the object information storage section 40 (see FIG. 5) in accordance with extraction rule 1. Accordingly, what will be displayed together with map data on the display section 16 is the remaining three sets of locale information, that is, the balloons 94 corresponding to the locale information with locale IDs Pt002, Pt004, and Pt006.

Alternatively, the object extraction section 21 may extract objects for display based on extraction rules 3, 4 which define the type of locale information. For example, based on extraction rule 4, the object extraction section 21 can extract only the objects whose type of locale information is “restaurant.” Accordingly, the display section 16 shows only the extracted balloons, that is, those balloons 94 which indicate restaurants. If the user is looking for restaurants using the map information, no balloons 94 unlikely to be selected by the user are displayed (only those for restaurants are displayed). Thus, operability for the user improves.

Given a predetermined number of balloons 94 which will be displayed with the map data, the object extraction section 21 may extract the same number of objects from the object information storage section 40 with an extraction method defined in extraction rule 5 or 6. For example, in accordance with extraction rule 5, the object extraction section 21 extracts the 100 most important sets of locale information.

The extraction rules are by no means limited to these examples; any rule may be used provided that in the extraction, the rule gives priority to objects which are likely to be selected by the user. In addition, any two or more extraction rules may be combined and set up for reference by the object extraction section 21. The digital television 1 may be pre-set to work with one of the extraction rules with which the extraction of objects will be done; otherwise, the television 1 may be set up allowing the user to choose any rules he likes.

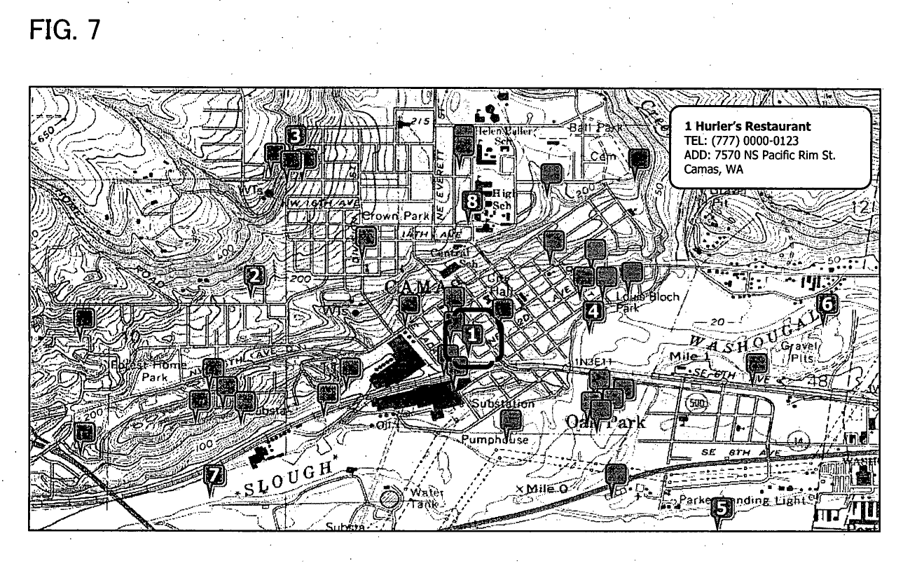

As described in the foregoing, the configuration of the object extraction section 21 and the extraction rule storage section 41 improves user operability by reducing the number of objects available for display on the display section 16. In other words, as shown in FIG. 7, if the numerous sets of locale information in the requested map data are to be all presented to the user, there are displayed many balloons on the display section. The user has to go through complex manipulation to find and select, from the numerous balloons being displayed, the balloons 94 whose locale information he wants to know. User manipulation is complex especially when he is using an input device which, like the manipulation section 19 (remote controller for a television), is extremely restricted in the types and number of available push keys. However, the object extraction section 21 extracts appropriate locale information which is likely to be selected by the user on the basis of the extraction rules. That reduces the number of balloons 94 which are unlikely to be selected by the user so that they are not displayed on the display section 16; the user can select desired balloons 94 with fewer key strokes before obtaining locale information. User operability thus improves.

### Assignment Rules

Next will be described assignment rules stored in the assignment rule storage section 42 for reference by the key assignment control section 23. The assignment rules define how the key assignment control section 23 assigns/associates selection objects which are selected by pressing the keys to the direction keys 91 on the manipulation section 19. In the present embodiment, the assignment rules define a key assignment so that objects which the user is likely to select are selected when the user presses the keys. Furthermore, the assignment may be defined considering the directions of the direction keys 91 and the positional relationship between the reference object being selected and a selection object candidate which will be selected next. The key assignment control section 23 may carry out a key assignment in accordance with a combination of assignment rules.

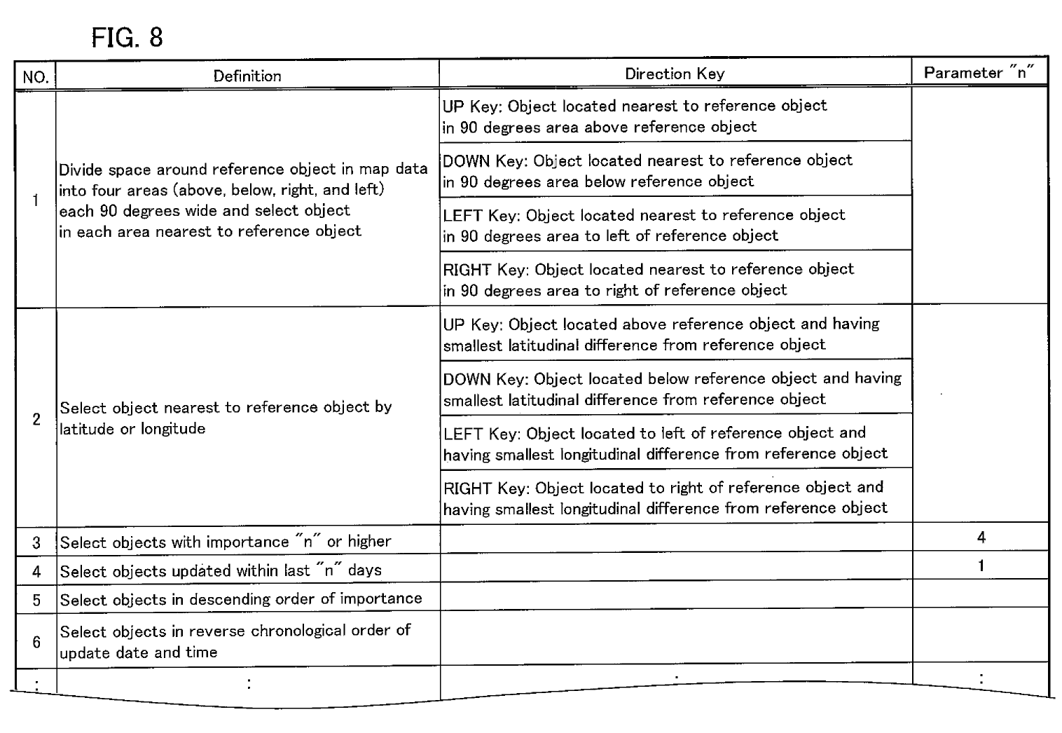

FIG. 8 is a table of an exemplary set of assignment rules stored in the assignment rule storage section 42. As shown in FIG. 8, the assignment rule storage section 42 stores information defining a key assignment methods and if necessary, thresholds, a maximum number of extracted objects, and other parameters for each rule. Furthermore, in the present embodiment, 4 types of direction keys 91, UP, DOWN, LEFT, and RIGHT, are used to specific an object. Accordingly, a more detailed definition may be stored in association with each direction key.

Assignment rule 1 defines a method for grouping objects into four directions (up, down, right, and left) relative to the reference object by using the positional information of the objects and assigning the directional groups with the respective direction keys.

The positional information is information on the positions of the objects. Referring to the positional information, the digital television 1 can recognize the display positions of the objects being displayed. Accordingly, the key assignment control section 23 can recognize the positional relationship between the selection objects, in other words, the reference object and various objects, and assign the direction keys suitable objects or functions. Concrete example of positional information is the latitude and longitude in locale information shown in FIG. 5. Another example is the coordinate position of the object (balloon 94) on the display section 16 when the image generated by the image processing section 22 is displayed.

A key assignment method based on positional information is concretely described in Tokukai 2001-175390.

Alternatively, as with assignment rule 2, a key assignment method may be defined considering latitude or longitude differences from the reference object using the positional information of objects. For example, the UP key may be associated with the object located above (north) the reference object with the smallest latitudinal difference. Similar definitions may be used for the three remaining directions.

Considering the positional information. the key assignment control section 23 can carry out a key assignment so that objects are selected in an order that is intuitively understandable to the user.

The key assignment control section 23 may carry out the key assignment using the importance and update date and time contained in the locale information in accordance with assignment rules 3 to 6, similarly to the extraction rules shown in FIG. 6. Accordingly, the keys are assigned so as to give higher priority to the objects which are likely to be selected by the user.

The key assignment control section 23 preferably performs the key assigning process in combination the assignment rules based on the positional information.

For example, by referring to both extraction rules 1 and 3, the key assignment control section 23 is capable of assigning the UP key one of the objects, located in the 90° area above the reference object and having an importance of 4 or greater, which has the shortest distance from the reference object. That provides a user interface intuitively understandable to the user and where the user can readily select an object with a few key strokes.

The assignment rules are by no means limited to these examples; any rule may be used provided that the rule is easy to use for the user and defines an assignment method which gives higher priority to the objects which are likely to be selected by the user. The digital television 1 may be pre-set to work with one of the assignment rules with which the key assignment is performed; otherwise, the digital television 1 may be set up allowing the user to choose any rules he likes.

### Process Flow for Digital Television

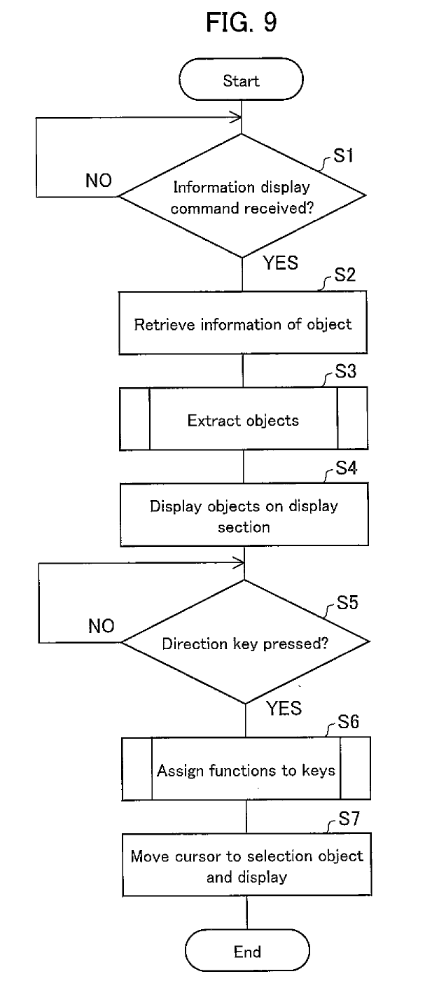

FIG. 9 is a flow chart illustrating a process flow being executed by the digital television 1 which executes the object extraction process and the key assigning process.

First, as the user enters an information display command (for example, a command to display a map of an area) on the manipulation section 19 (YES in step 1), The information retrieval section 20 obtains objects and attribute information of the objects. Here, map data, information on the locales in the map data, and the locale information for the locales are obtained from the map service providing server 2 (step 2).

Subsequently, the object extraction section 21 extracts only the locale (locale information) which will be actually displayed as balloons 94 on the display section 16 (step 3) based on the pre-set one or more of the extraction rules stored in the extraction rule storage section 41. In so doing, the cursor control section 24 obtains the central coordinate position designated by the user and controls a cursor position so that the cursor 96 appears on a balloon 94 displayed at the coordinate position.

The image processing section 22 then generates an image from the map data obtained by the information retrieval section 20 including the balloons 94 for the locales extracted by the object extraction section 21 and the cursor 96 pointing to the balloon 94 located at the central coordinate position. The generated image is supplied to the image superimposer section 14 and the display section 16 via the input/output control section; the map data and the locale information are displayed on the display section 16 (step 4).

As an object select command signal is entered by pressing one of the direction keys 91 on the manipulation section 19 (YES in step 5), the key assignment control section 23 performs the key assigning process. In other words, the key assignment control section 23 performs the key assigning process based on the pre-set one or more of the extraction rules stored in the assignment rule storage section 42. Specifically, a next selection object which will be selected by pressing the direction keys 91 in step 5 is identified in the objects being displayed on the display section 16 (step 6). In so doing, the cursor control section 24 determines a display position for the cursor 96 and transfers the display position to the image processing section 22 to display the cursor 96 pointing to the object identified by the key assignment control section 23.

Finally, the image processing section 22 moves the cursor 96 to the object which has newly become a selection object under the control of the cursor control section 24 and displays the resultant cursor 96 on the display section 16 (step 7).

According to the method, the object extraction section 21 extracts only the objects which are likely to be selected by the user from the objects stored in the object information storage section 40 based on the extraction rules stored in the extraction rule storage section 41 so as to reduce the number of objects displayed on the display section 16. Accordingly, the user can select a desired object with fewer key strokes. As a result, user operability improves in selecting objects.

Furthermore, the key assignment control section 23 recognizes one of the objects displayed on the display section 16 which corresponds to the direction key 91 pressed by the user as a selection object based on the assignment rules stored in the assignment rule storage section 42. The assignment rules define a key assignment method using the positional information of the objects and the attribute information (for example, the importance, update date and time, etc. of locale information) given to the objects, so as to give higher priority to the objects which are likely to be selected by the user.

That provides a user interface intuitively understandable to the user and where the user can readily select an object with fewer key strokes.

### Statistical Processing of Attribute Information

The parameter (parameter “n”) stored in the extraction rule storage section 41 and the assignment rule storage section 42 for each rule may be changed to any given value automatically by the digital television 1 or by the user so as to enable suitable extraction (or assignment). The following will describe how the parameter is adjusted.

The statistical processing section 25 statistically processes attribute information (attribute values) of objects (for example, importance, update date and time, etc. for locale information) so that the parameter (threshold) can be adjusted to a suitable value automatically or by the user. More specifically, the section 25, for example, derives a relationship between attribute values and the total count of objects (or ranks). Furthermore, there may be provided a parameter determining section 26 which determines a suitable parameter by analyzing the outputs of statistical results from the statistical processing section 25 or the ranking of the objects made by the key assignment control section 23.

The statistical processing section 25 in FIG. 1 carries out statistical processing on objects using attribute information given to the objects. Specifically, in the present embodiment, the section 25 carries out the statistical processing using the locale information of all or some of the locales managed by way of the locale information DB121 in the map service providing server 2. In the present embodiment, the statistical processing section 25 carries out the statistical processing as to the locales using the locale information retrieved by the information retrieval section 20 and stored in the object information storage section 40. Results of the statistical processing carried out by the statistical processing section 25 are stored to the statistical result storage section 43.

For example, suppose that the information retrieval section 20 has retrieved 200 sets of locale information for locales shown in FIG. 5 from the map service providing server 2 and stores them to the object information storage section 40.

The following will describe, as an example, statistical processing performed on the importance to change the parameters in extraction rule 1 (FIG. 6) for the extraction rule storage section 41 and assignment rule 3 (FIG. 8) for the assignment rule storage section 42.

First, the statistical processing section 25 obtains 200 sets of importance from the object information storage section 40 and derives a relationship between the importance and the total count (ranks).

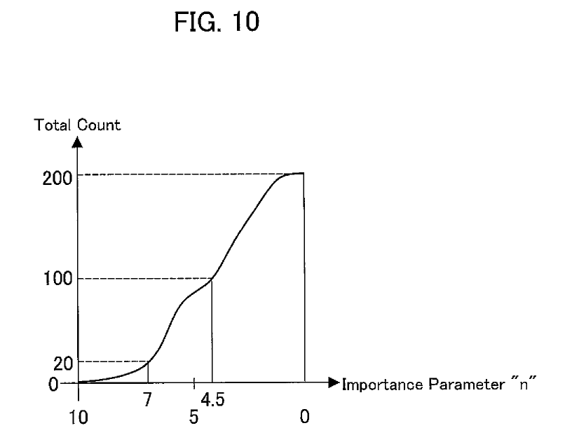

FIG. 10 is a graph representing importance vs. object count derived by the statistical processing section 25. The horizontal axis shows an importance parameter. A maximum possible level of importance (for example, 10) is plotted at point 0 on the X coordinate, and the value falls when moving to the right.

The vertical axis shows the total count of locales at which the importance satisfies the foregoing conditions, or specifically, at which the importance has a value more than or equal to the importance plotted on the horizontal axis. “0” is plotted at point 0 on the Y coordinate, and the object count increases when moving upward. Since statistical processing is done on 200 sets, the maximum value on the Y coordinate is 200.

The statistical processing section 25 derives a relationship between the importance and the object count (graph in FIG. 10) as statistical results and stores the results to the statistical result storage section 43.

The statistical processing section 25 may carry out the statistical processing using positional information (latitude, longitude), other attribute information (update date and time), etc. of the objects, rather than the importance.

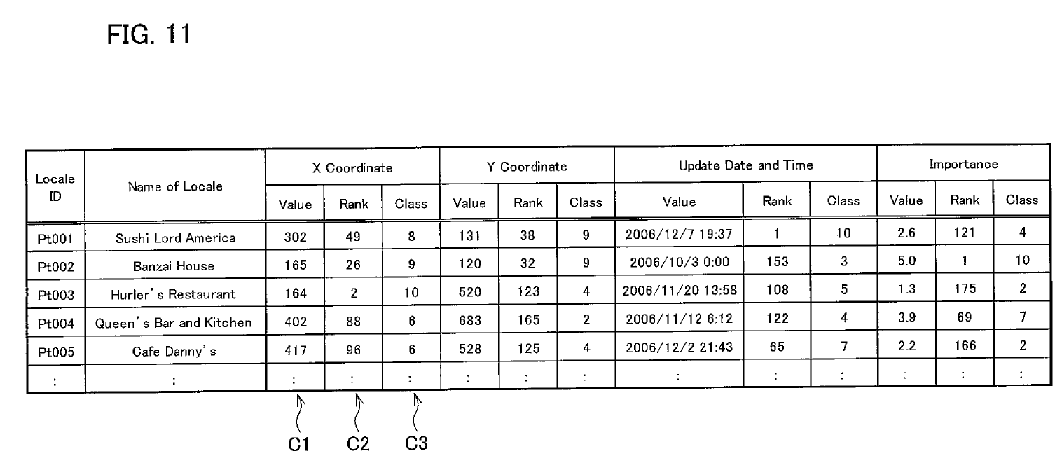

FIG. 11 is a table of exemplary results of statistical processing stored in the statistical result storage section 43 and derived by the statistical processing section 25.

As shown in FIG. 11, the statistical processing section 25 carries out statistical processing on the locale information for the locales stored in the object information storage section 40. Specifically, first, the statistical processing section 25 converts the longitudinal information shown in FIG. 5 to X coordinate values on the display section 16 (column C1). After deriving the X coordinate values of the 200 objects, next, the key assignment control section 23 ranks the objects based on the X coordinate values (column C2). The statistical processing section 25 divides the 200 locales based on the X coordinate values. In the example shown in FIG. 11, the section 25 divides the locales into 10 classes (column C3). The statistical processing section 25 and the key assignment control section 23 do similar conversion of the latitudinal information to Y coordinate values, ranking, and dividing into 10 classes similarly to longitudinal information. The ranking and dividing into 10 classes are done with no changes to the values of the update date and time and importance shown in FIG. 5. In the present embodiment, all the 200 sets of locale information are divided into classes of equal size. Therefore, the 200 sets of locale information are divided into classes of 20 sets each, with the top-ranked 20 sets going to class 10, the next 20 sets going to class 9, and so forth.

The X and Y coordinate values represent a coordinate position on the display section 16. In the present embodiment, at the upper left corner of the display, (X, Y)=(0, 0). The X coordinate value increases toward the right, and the Y coordinate value increases toward the bottom.

The statistical results generated by the statistical processing section 25 as in the foregoing (shown in the table in FIG. 11) are stored to the statistical result storage section 43.

Accordingly, the object extraction section 21 (key assignment control section 23) is capable of ranking, in accordance with the various rules, the objects to determine an assignment order and appropriately executing the object extraction process (key assigning process) by using the statistical results stored in the statistical result storage section 43.

### Automatic Parameter Setting

Next, the parameter determining section 26 analyzes the statistical results stored in the statistical result storage section 43 and determines parameters (thresholds) so that the object extraction section 21 and the key assignment control section 23 can process the objects appropriately.

For example, if it is predetermined that the objects displayed on the display section 16 should be reduced to half the original count in the object extraction process by the object extraction section 21, the parameter determining section 26 determines a parameter for extraction rule 1 as follows.

The parameter determining section 26 obtains the graph shown in FIG. 10 from the statistical result storage section 43 and calculates an optimal importance threshold (parameter) to reduce the object count to 100 in the object extraction process. According to the example shown in FIG. 10, the parameter determining section 26 can determine an optimal threshold to be 4.5.

The parameter determined by the parameter determining section 26 is stored to the extraction rule storage section 41. In other words, in the example shown in FIG. 6, the parameter “n” of extraction rule 1 is changed from 3 to 4.5.

Alternatively, the parameter determining section (attribute value identifying means) 26 selects an object ranked 100th from the objects ranked by the key assignment control section 23 to find out the importance of the 100th object (4.5 in the example). If the importance of the 100th object, or 4.5, is used as a threshold, 100 objects with an importance of 4.5 or higher are extracted.

Accordingly, the object extraction section 21 can filter the locale information stored in the object information storage section 40 so that half of the objects which are ranked higher than others in importance will be displayed.

In addition, likewise, the parameter determining section 26 can determine a parameter for assignment rule 3 referenced by the key assignment control section 23 in the key assigning process.

Suppose, as an example, a situation where it is predetermined that the number of objects actually selectable by the user pressing the direction keys 91 on the manipulation section 19 should be limited to about 20. The parameter determining section 26 obtains the graph from the statistical result storage section 43 and calculates an importance threshold so as to limit the selection objects to which keys can be assigned to about 20. According to example shown in FIG. 10, the parameter determining section 26 can determine an optimal threshold to be 7.

The parameter determined by the parameter determining section 26 is stored to the assignment rule storage section 42. In other words, in the example shown in FIG. 8, the parameter “n” of assignment rule 3 is changed from 4 to 7.

Accordingly, the key assignment control section 23 can assign only the locales with an importance of 7 or higher to the direction keys 91. The user can efficiently select only the locales having an importance of 7 or higher.

The statistical processing section 25 can perform a statistical process on the information of update date and time similarly to the importance. The parameter determining section 26 can determine a suitable update date and time threshold.

### Parameter Setting by User

The user may make specify parameters (thresholds) used with the extraction and assignment rules.

Suppose, as an example, a situation where the user is allowed to select any parameter from 6-class importance values regarding the importance parameter of extraction rule 1 shown in FIG. 6.

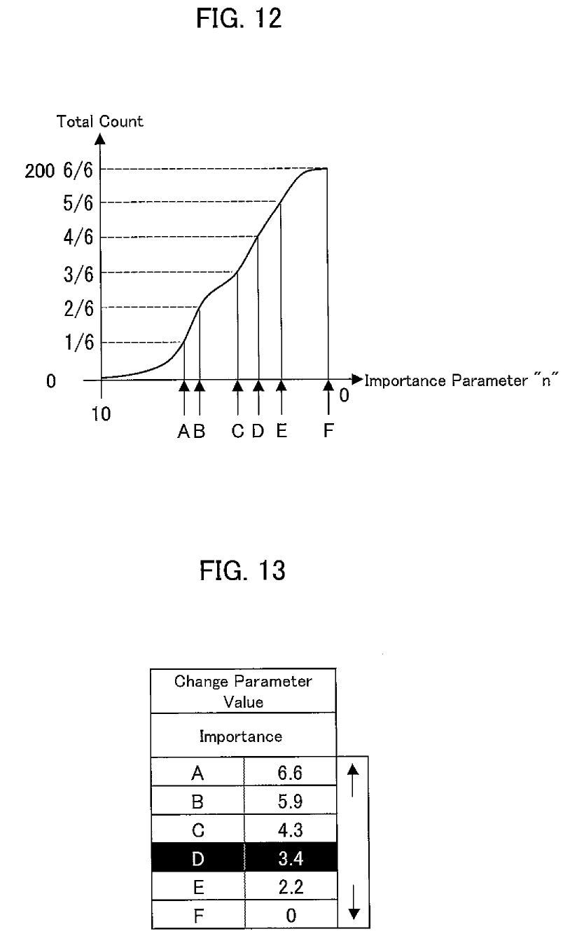

As shown in FIG. 12, the parameter determining section 26 calculates six importance thresholds (that is, from the threshold by way of which all the objects (6/6) will be extracted to the threshold by way of which 1/6 of all the objects are extracted) based on the importance vs. object count graph produced by the statistical processing section 25, so as to divide 200 locales into six classes of equal size. Here, the parameter determining section 26 calculates the six thresholds A to F starting with the highest threshold A then sequentially down to the lowest threshold F.

The candidates for the six thresholds calculated by the parameter determining section 26 are stored to the statistical result storage section 43 and supplied to the display section 16 by the image processing section 22. For example, the image processing section 22 may generate a GUT display like the one shown in FIG. 13 so that the user can select the six thresholds using the manipulation section 19.

The parameter determining section 26 receives the threshold designated by the user through the manipulation section 19 (for example, threshold D, “3.4,” shown in FIG. 13) and stores the threshold D (=3.4) to the extraction rule storage section 41. In other words, in the example shown in FIG. 6, the parameter “n” of extraction rule 1 is changed from 3 to 3.4.

The parameter determining section 26 can determine the importance and update date and time parameter “n” of the assignment rules in the assignment rule storage section 42 in accordance with an user command by a similar method.

Regarding the parameter “n” of rules imposing an upper limit on the number of objects displayed simultaneously on the display section 16, as in extraction rules 5, 6, the parameter determining section 26 may determine the parameter based on specification information of the digital television 1.

For example, the specification information for the display section 16 of the digital television 1 may be used. Concrete examples of the specification information include the resolution and screen size of the display section 16. The higher the resolution of the display section 16 and the larger the screen size, the more objects can be displayed with high fidelity. Therefore, the maximum number of objects displayed is preferably set to a higher value with an increasing resolution and an increasing greater screen size of the digital television 1. To this end, an association table which indicates the relationship between values of parameters which should be determined and specification information may be stored to the storage section 17 in advance.

The parameter determining section 26 determines an optimal upper limit value from the association table based on the specification information for the display section 16 stored in advance in the storage section 17 and stores the value to the extraction rule storage section 41 as a parameter “n.”

Accordingly, the object extraction section 21 is capable of sequentially extracting a suitable number of objects that should be displayed in accordance with the specifications of the display section 16 in descending order of importance (or in reverse chronological order).

Alternatively, the parameter determining section 26 may receive the upper limit value designated by the user through the manipulation section 19 and store the upper limit value to the extraction rule storage section 41 as a parameter “n.”

### Object Extraction Process

Next will be described another example of the object extraction process carried out by the object extraction section 21 in FIG. 1.

### Reducing Objects by Grouping

The object extraction section 21 is capable of gradually reducing the objects displayed on the display section 16 by grouping the objects using attribute information of the objects. The following will describe an example in which the objects being displayed on the display section 16 are divided into two groups, old and new, based on update date and time information given to the locales.

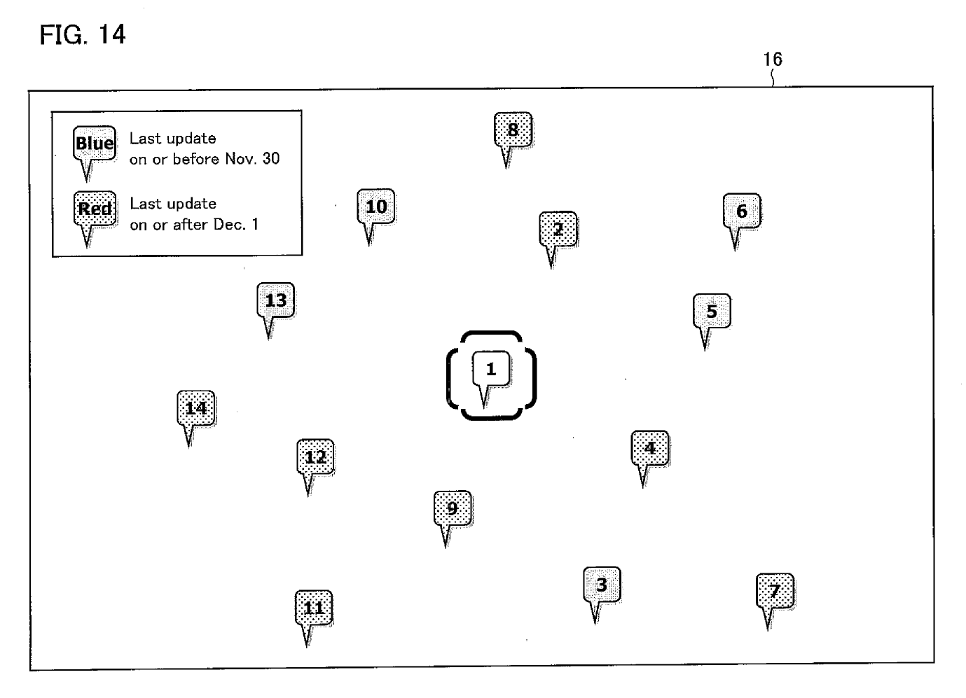

FIG. 14 is an exemplary display of two groups (grouping) of objects, or balloons 94, on the display section 16.

First, the object extraction section 21 extracts objects based on a predetermined extraction rule in accordance with a command signal for a map information display and displays them on the display section 16. Furthermore, the object extraction section 21 divides the extracted objects into a first group and a second group based on the statistical results stored in the statistical result storage section 43. The objects with a relatively new update date and time belong to the first group, and those with a relatively old update date and time belong to the second group. The threshold of the grouping is determined by the parameter determining section 26 based on the statistical results from the statistical processing section 25. Suppose, for example, the update date and time is Dec. 1, 2006 or later for the first group and Nov. 30, 2006 or before for the second group.

The image processing section 22 generates an image in which the objects in the first and second groups extracted by the object extraction section 21 are displayed as balloons on map data and supplies the image to the image superimposer section 14 and the display section 16. In so doing, the objects of different groups may be displayed in different colors so that the user can readily recognize which locale (balloon) belongs to which group. In the example shown in FIG. 14, the balloons of the first group with a relatively new update date and time are displayed in red, and the balloons of the second group with a relatively old update date and time are displayed in blue.

The user can select the balloons displayed on the display section 16 by pressing the direction keys 91 on the manipulation section 19 while the display section 16 is in the state shown in FIG. 14. In this case, the key assignment control section 23 determines which balloon is selected when a direction key 91 is pressed, in accordance with one or more of the assignment rules shown in FIG. 8.

For example, the keys may be assigned so to allow the user to select only the red balloons or so that red balloons are displayed one after the other in the order or update date and time every time an UP or DOWN key is pressed and blue balloons are displayed one after the other in the order of update date and time every time an LEFT or RIGHT key is pressed.

Accordingly, the user can efficiently select a desired object from the objects grouped by update date and time using the direction keys.

Furthermore, one of the two groups may be extracted to reduce the number of objects displayed on the display section 16 to half.

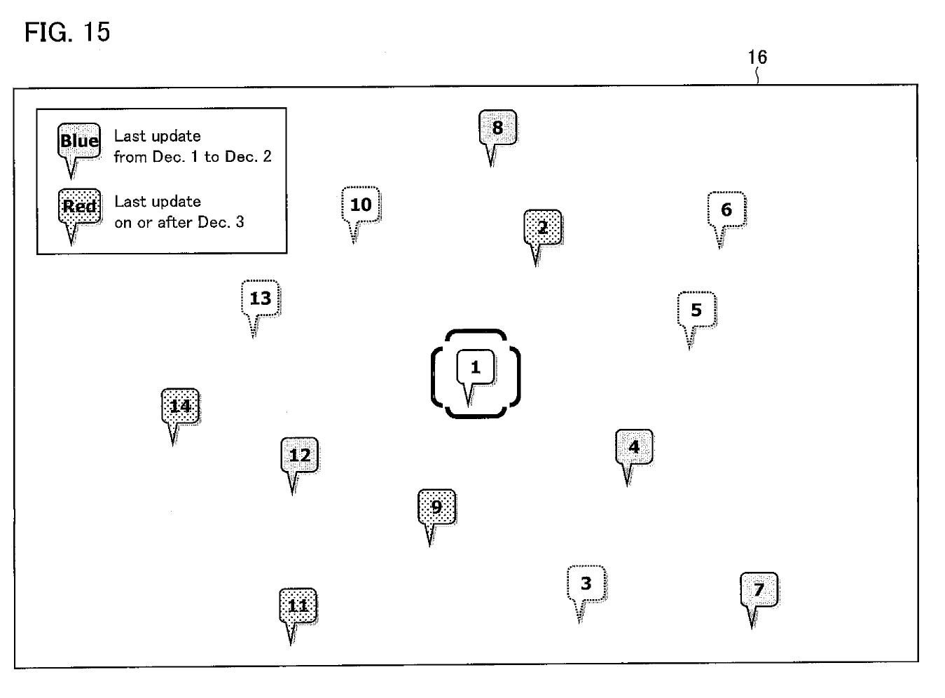

In the present embodiment, this function of group filtering is assigned to the color key 93 on the manipulation section 19 shown in FIG. 3. Specifically, if the user presses a red key in the color keys 93 while the display is in the state shown in FIG. 14, only the balloons of the same color as the key are displayed on the display section 16 as shown in FIG. 15.

As the red key is pressed, the object extraction section 21 extracts only the objects (red balloons) of the first group which are associated with the red key. The object extraction section 21 this time obtains from the parameter determining section 26 a threshold to divide the objects of the first group into two groups (for example, December 2 or before and December 3 or after) and divides the objects of the first group into a third group with a relatively new update date and time of December 3 or after and a fourth group with a relatively old update date and time of December 2 or before.

The image processing section 22 displays map information on the display section 16 with the balloons for the locales of the third group in red and the balloons for the locales of the fourth group in blue by a similar method (see FIG. 15).

Every time these procedures are repeated, the number of objects is reduced in half by grouping the objects using update date and time. The user has only to manipulate two keys of different colors and can still efficiently narrow the selections down toward a target object. After sufficiently reducing the objects being displayed, the user can easily select the target object. As a result, even if many objects are being displayed on the display section 16 and have to be manipulated using a limited number of manipulators (ex. the direction keys 91), user operability still improves.

The image processing section 22 may generate an image so as to display by another method the remaining group of the objects which were not extracted in the procedures above. For example, a balloon may be displayed with a broken line or as being translucent (FIG. 15). Alternatively, the balloon may be reduced in size.

### Filtering by Type

The object extraction section 21 may filter objects for display on the display section 16 using preference information of the user stored in advance in the digital television 1. Before using map providing service, the user can make settings as to which type of locale information should be displayed on the map. For example, the user always wants information on restaurants; the “preference information” is set to “restaurants.” The setting is stored in the storage section 17. Specifically, the digital television 1 is set up to refer to extraction rule 4 shown in FIG. 6.

Accordingly, the object extraction section 21 can extract, from the objects stored in the object information storage section 40, only the locales for which the stored type of locale information indicates “restaurants.” Therefore, the user can obtain a map in which only desired locale information of restaurants is displayed in the form of balloons and efficiently select a target object (locale information of a restaurants).

### Key Assigning Process

Next will be described another example of the key assigning process executed by the key assignment control section 23.

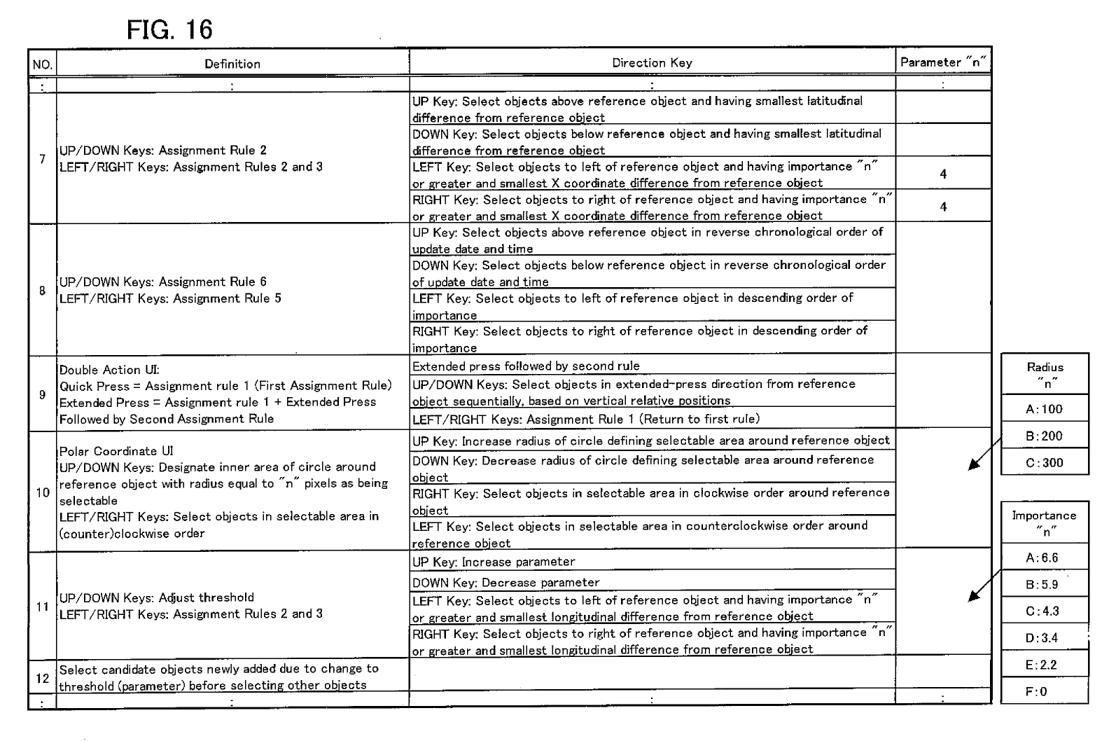

FIG. 16 is a table of another exemplary set of assignment rules stored in the assignment rule storage section 42. The assignment rules shown in FIG. 16 are stored in the assignment rule storage section 42 as are the rules in FIG. 8. In other words, the section 42 stores information defining key assignment methods, and if necessary, thresholds, a maximum number of extracted objects, and other parameters for each rule. The section 42 also stores further detailed definitions for each of four direction keys, UP, DOWN, LEFT, and RIGHT.

The configuration allows different definitions of assignment rules for each direction key. Therefore, rules can be defined which involve different selection criteria for each of the four UP, DOWN, LEFT, and RIGHT keys. In addition, different operations may be assigned to the UP and DOWN keys and the LEFT and RIGHT keys. For example, rules may be defined which involve different selection criteria for the UP and DOWN keys and the LEFT and RIGHT keys (key assigning process 1). Alternatively, object selecting functions may be assigned only to two direction keys (either UP and DOWN keys or LEFT and RIGHT keys), and other functions than the object selecting functions may be assigned to the other two direction keys (key assigning process 2). The other functions refer, for example, to switching between selection criteria and changing thresholds.

### Key Assigning Process 1

The key assignment control section 23 is capable of assigning functions to the UP and DOWN keys and the LEFT and RIGHT keys so that the two pairs of keys use different object selecting criteria in accordance with the assignment rules shown in FIG. 16.

### Concrete Example 1

The key assignment control section 23 may execute a key assigning process in accordance with assignment rule 7 shown in FIG. 16. Specifically, functions are assigned to the UP and DOWN keys based on positional information (the latitude, that is, the Y coordinate value in FIG. 11, of each locale) and to the LEFT and RIGHT keys based on a combination of the longitude (X coordinate value) and importance.

If a received command signal indicates a press down of either the LEFT or RIGHT key, the key assignment control section 23 obtains the importance value for each locale from the object information storage section 40. The section 23 then assigns functions to the keys so as to identify, as a selection object, a locale that has an importance of 4 or higher, is located to the left (or right) of a reference locale, and has a smaller difference in X coordinate value from the reference locale than any other candidate locales. The cursor control section 24 is capable of correctly identifying a selection object in accordance with the executed key assignment if a corresponding key is actually pressed.

Accordingly, the user can select an object using the UP and DOWN keys based only on the relative position of the object. By using the LEFT and RIGHT keys, the user can select an object based on the importance, as well as the relative position, of the object. Hence, the user can use the UP and DOWN keys and the LEFT and RIGHT keys for different purposes to efficiently select a target object.

### Concrete Example 2

The key assignment control section 23 may execute a key assigning process in accordance with assignment rule 8. Specifically, functions are assigned to the UP and DOWN keys similarly to assignment rule 6 in FIG. 8 so that objects are sequentially selected in reverse chronological order of update date and time of the locales in a predetermined area and to the LEFT and RIGHT keys similarly to assignment rule 5 so that objects are sequentially selected in descending order of importance of the locales in a predetermined area.

The key assignment control section 23 assigns functions to the UP and DOWN keys so as to obtain an update date and time ranking of locales (FIG. 11) from the statistical result storage section 43 and sequentially select locales above (or below) a reference locale in a predetermined area in reverse chronological order of update date and time. For example, every time the UP key is pressed, locales above the reference locale in a predetermined area are sequentially selected in reverse chronological order of update date and time.

The key assignment control section 23 assigns functions to the LEFT and RIGHT keys so as to obtain an importance ranking of locales (FIG. 11) from the statistical result storage section 43 and select locales to the left (right) of a reference locale in a predetermined area in descending order of the importance. Accordingly, for example, every time the RIGHT key is pressed, locales to the right of the reference locale in a predetermined area are selected in descending order of the importance under the control of the cursor control section 24.

Accordingly, the user can select an object using the UP and DOWN keys based on the relative position and the newness of the update date and time of the object. By using the LEFT and RIGHT keys, the user can select an object based on the importance, as well as the relative position, of the object. In other words, the user can use the UP and DOWN keys and the LEFT and RIGHT keys for different purposes to efficiently select a target object based on two selection criteria.

Furthermore, when a direction key is pressed, a guide which shows the order in which objects are selected (assignment order) may be displayed for the user. Upon determining an assignment order for the direction keys and the objects based on the update date and time or importance ranking, the key assignment control section 23 stores the assignment order to the assignment order storage section 44 (FIG. 1) in the storage section 17. The image processing section 22 produces a guide image in accordance with results the key assignment determined by key assignment control section 23.

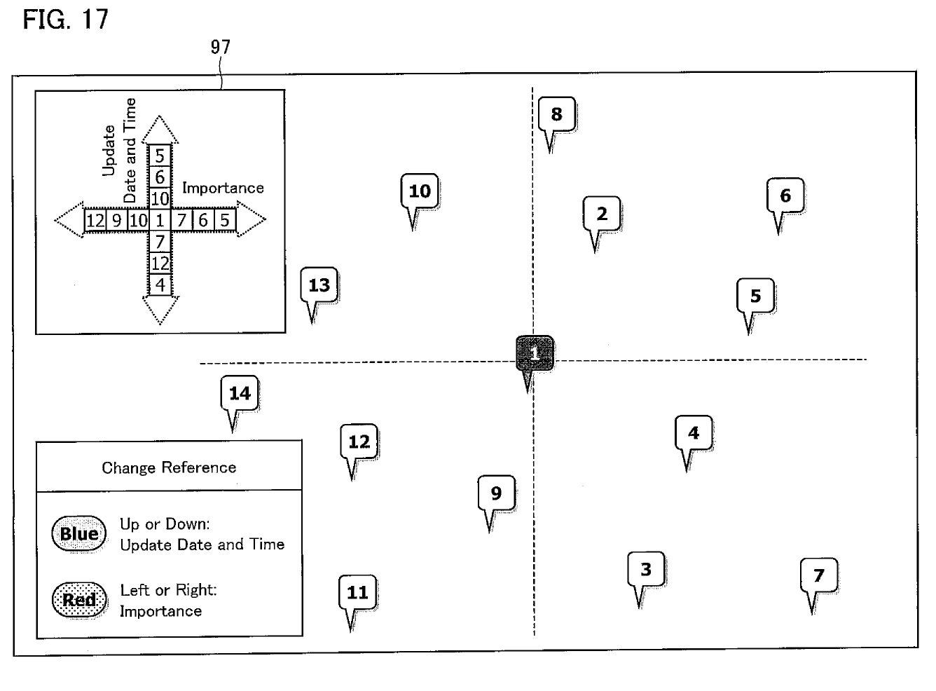

FIG. 17 is an exemplary display of a guide produced by the image processing section 22. From the guide 97 shown in FIG. 17, the user understands that when the UP key is pressed, balloons are sequentially selected based on update date and time in the order of balloon 10, balloon 6, balloon 5, and so forth, starting with balloon 1 (reference balloon). Next, The user can efficiently select a target object because he is now informed in advance which direction key should be pressed to select which object.

Furthermore, the key assignment control section 23 may switch between object selection criteria in response to an input from the color keys 93 (FIG. 3) on the manipulation section 19. For example, if a blue key is pressed, the selection criterion (update date and time) for the UP and DOWN keys may be switched to another criterion. If a red key is pressed, the selection criterion (importance) for the LEFT and RIGHT keys may be switched to another criterion.

Accordingly, the user can easily control the operation of the key assignment control section 23 so that objects are selected using desired selection criteria.

### Concrete Example 3

### Double Action User Interface

The key assignment control section 23 may execute a key assigning process in accordance with assignment rule 9. Assignment rule 9 defines switching between two assignment rules (first and second) in response to two different actions in pressing a direction key (quick press/extended press). The key assignment control section 23 associates the direction keys to the objects in accordance with the first assignment rule in response to a first action made on a direction key. The section 23 switches to a mode in which objects are selected in accordance with a second assignment rule in response to a second operation. In the second assignment rule, a function of returning to the first assignment rule may be assigned to any one of the UP, DOWN, LEFT and RIGHT keys. More specific description follows.

While the user is pressing a direction key 91 by the first action (quick press), the key assignment control section 23 assigns functions to keys so that objects (balloons) are selected based on the relative positions of the balloons in accordance with the first assignment rule (assignment rule 1 shown in FIG. 8). For example, if the DOWN key is pressed while the display is in the state shown in FIG. 17 (balloon 1 is being selected), the key assignment control section 23 assigns functions so as to identify balloon 9 as a next selection object; if the RIGHT key is pressed, the section 23 assigns functions so as to identify balloon 4 as a selection object.

Here, if the user presses a direction key 91 (for example, the RIGHT key) by the second operation (extended press) while balloon 1 is being selected as in FIG. 17, the section 23 assigns functions as follows. First, similarly to assignment rule 1, the section 23 assigns functions so as to identify a next selection object which will be then designated a new reference object. Here, the RIGHT key is assigned balloon 4. Accordingly, if the RIGHT key is pressed, the cursor control section 24 selects balloon 4 and designates balloon 4 a new reference object.

FIG. 18 is an exemplary display after the second operation by a user.

As the direction keys 91 is pressed by the second operation, the key assignment control section 23 further switches to a mode so that functions are assigned to keys in accordance with the second assignment rule starting from the next assignment. The second assignment rule in assignment rule 9 shown in FIG. 16 defines a key assignment with different object selection criteria for the UP and DOWN keys and the LEFT and RIGHT keys.

More specifically, for the DOWN (UP) key, an assignment rule is defined: “select objects located in ‘the extended-press direction in the first action’ from a reference object sequentially starting with an object at the top (bottom).” For the LEFT and RIGHT keys, another assignment rule is defined: “select objects similarly to assignment rule 1 and return to the first assignment rule mode.”

Accordingly, for example, when the reference balloon is balloon 1, if the RIGHT key is pressed for an extended period, balloon 4 is selected and the operation switches to the second assignment rule mode.

Furthermore, the key assignment control section 23 carries out a key assignment so that if the DOWN key is pressed while the reference balloon is balloon 4, balloons located in “the extended-press direction in the first action” from balloon 4 (here, to the right of balloon 4) are sequentially selected starting with the balloon at the top (in ascending order of Y coordinate value). Conversely, the key assignment control section 23 carries out a key assignment so that if the UP key is pressed, balloons to the right of balloon 4 are sequentially selected starting with the balloon at the bottom.

Furthermore, the key assignment control section 23 may identify a candidate for a next selection object to the reference object selected by an extended press in accordance with the second assignment rule and sort on the basis of relative positions, to transfer the resultant information to the image processing section 22. As shown in FIG. 18, the image processing section 22 produces a list 98 from the information in which candidates for a next selection object are sorted for presentation to the user. The display section 16 then displays the list. Accordingly, the user can know in advance which objects are selectable using the UP and DOWN keys.

Accordingly, after the second operation, the key assignment control section 23 can carry out a key assignment in a mode where object selection criteria are different for the UP and DOWN keys and for the LEFT and RIGHT keys. The user can easily set up the mode by simply using the two actions for different purposes. As would be understood from the foregoing description, the user can easily select a mode in which he can more efficiently select a target object. As a result, the user can enjoy improved operability.

The definition of the second assignment rule is by no means limited to the above example. For example, the second assignment rule may be define sorting of candidates for a next selection object in descending order of importance or in reverse chronological order of update date and time.

Alternatively, apart from the examples above, the following is another example of the configuration in which two different key-press actions causes a switching between two key assignment operation for having different selection criteria.

If a direction key input by the first action (quick press) is received, the key assignment control section 23 carries out a key assignment in accordance with assignment rule 1 starting from ordinary relative positions. In contrast, if a direction key input by the second operation (extended press) is received, the section 23 carries out a key assignment in accordance with a different assignment rules (ex. assignment rule 2).

Accordingly, for example, if the RIGHT key is pressed for an extended period, the cursor control section 24 sequentially selects all the objects to the right of a reference object starting with the object close to the reference object in terms of X coordinate values. Furthermore, while the key is being pressed and held down for an extended period, it is preferable if the objects are selected in the above order and the display of the cursor 96 indicating that an object being selected is transitioned until the key is released.

Accordingly, all the direction keys can be assigned object selecting operation. The user can readily switching between selection criteria (assignment rules followed by the section 23) by simply using two different actions. The user can efficiently select a target object and enjoy improved operability.

The assignment order may be determined considering also attribute information other than the relative positions of the objects. For example, the assignment order may be determined with the update date and time considered if a direction key is pressed quickly and the importance considered if a direction key is pressed for an extended period.

### Key Assigning Process 2

The key assignment control section 23 may assign switching between selection criteria to one key of either the UP/DOWN or LEFT/RIGHT key pair and object selection to only the other direction key pair in accordance with assignment rules shown in FIG. 16.

### Concrete Example 1

### Polar Coordinate User Interface

The key assignment control section 23 may carry out a key assignment in accordance with assignment rule 10. Specifically, the section 23 assigns the UP and DOWN keys a function of specifying a radius for a circle around a reference object. If an object is located within that circle, the object is selectable. The radius is defined in terms of a pixel count “n.” In addition, for the LEFT and RIGHT keys, rules are defined according to which the objects within the specified selectable area are sequentially selected in clockwise order (or in counterclockwise order).

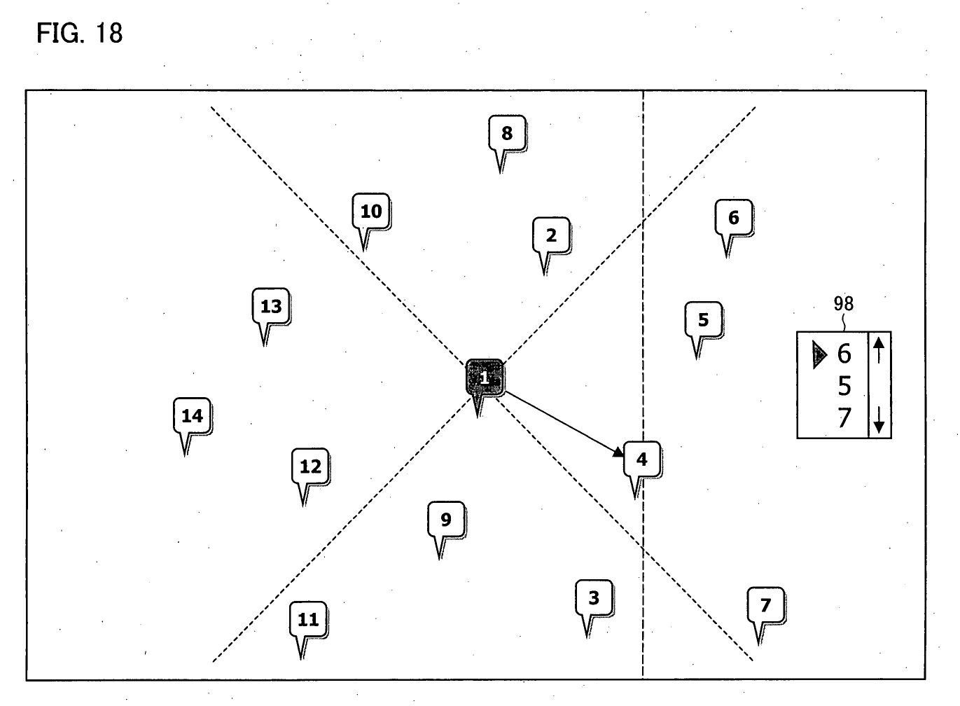

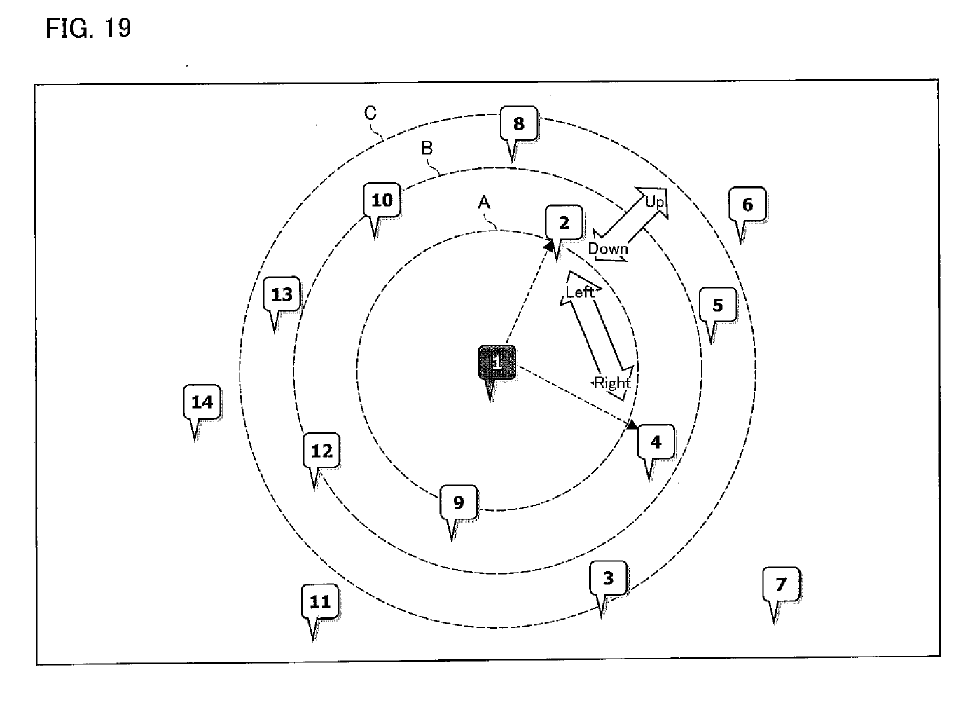

FIG. 19 is a diagram illustrating the direction keys 91 and their assigned actions in a polar coordinate UI.

For example, when balloon 1 is the reference object, the key assignment control section 23 obtains the default value (for example, A=100) of the parameter “n” of assignment rule 10 shown in FIG. 16 and specifies a circle with a radius equal to 100 pixels around balloon 1 (broken line circle A) as a selectable area. The image processing section 22 may generate an image to display the information on the selectable area specified by the key assignment control section 23 (broken line circles A to C shown in FIG. 19) on the display section 16.

In the present embodiment, the UP key is assigned a function of increasing the radius of the circle defining a selectable area around the reference object. Accordingly, in the example shown in FIG. 19, as the UP key is pressed by the user, the key assignment control section 23 obtains a parameter “n” immediately greater than the current value (for example, B=200) and specifies a new selectable area using that value. If the DOWN key is pressed, the section 23 obtains a parameter “n” immediately smaller than the current value. For example, if the current radius is 300 pixels (broken line circle C), 200 pixels (broken line circle B) is obtained.

The radius parameter “n” may be obtained by referring to predetermined values as above. Alternatively, the distances between the objects and the reference object may be calculated and obtained radius as the parameter “n.”

Alternatively, the parameter determining section 26 may automatically determine the radius parameter “n.” Specifically, if the user wants to have a predetermined number (for example, 100) of objects displayed, the parameter determining section 26 may calculate a minimum radius for a circle so that 100 objects are located within the selectable area and set the radius parameter “n” to that value.

A RIGHT key assignment rule defines selecting objects within the specified selectable area in clockwise order around the reference object. For example, when middle broken line circle B shown in FIG. 19 indicates the current selectable area, the key assignment control section 23 sequentially assigns the RIGHT key the balloons within the selectable area in clockwise order, like balloon 2, balloon 4, balloon 9, balloon 10, balloon 2, and so forth. Since counterclockwise selection is defined for the LEFT key, the key assignment control section 23 sequentially assigns the LEFT key the objects in the reverse order to the foregoing order.

In this manner, the UP and DOWN keys are assigned the functions of adjusting the selectable area around the reference object. The user can specify a desired area and efficiently select a target object. In addition, when an object is finally selected, objects are sequentially selected in (counter)clockwise order around the reference object using the LEFT and RIGHT keys. Accordingly, the user can easily reach the target object on a intuitively understandable user interface. User operability thus improves.

### Concrete Example 2

Alternatively, the key assignment control section 23 may perform a key assigning process in accordance with assignment rule 11. Specifically, the section 23 assigns a function of adjusting the importance parameter “n” (threshold) to the UP and DOWN keys. For the LEFT and RIGHT keys, an assignment rule is defined which is a combination of assignment rules 2 and 3. Threshold adjustment, as mentioned under the heading Statistical Processing of Attribute Information, is to calculate two or more candidates for a parameter “n” (threshold) needed in the key assigning process and let the user select any desirable threshold. The candidates for the threshold is displayed on the display section 16 as shown in FIG. 13, as an example, for selection by the user.

In the present embodiment, the user can specify a desired importance “n” from the list shown in FIG. 13 by pressing the UP and DOWN keys. As the UP or DOWN key is pressed, the parameter determining section 26 determines the parameter (importance “n”) to which the key assignment control section 23 should make a reference.

The user then presses the LEFT and RIGHT keys to select a target object from the objects having an importance higher than or equal to the parameter determined by the parameter determining section 26, that is, specified by the user.

For example, if the RIGHT key is pressed when “D: 3.4” is being specified among the parameters shown in FIG. 13, the key assignment control section 23 identifies an object, among the objects to the right of the reference object, that has an importance of 3.4 or higher and that has a smaller difference in Y coordinate value from the reference object than any other locales as a selection object.

In this manner, the UP and DOWN keys are assigned a function of adjusting the importance threshold. That allows the user to readily expand or narrow the range of the objects on which a key assignment is carried out. In addition, the user can efficiently select a target object from the objects which meet the user-specified threshold conditions using the LEFT and RIGHT keys based on relative positions in the left-right directions. As a result, user operability improves.

Furthermore, the key assignment control section 23 may carry out a key assignment in accordance with a combination of assignment rules 11 and 12. A key assignment may be carried out so that if selectable objects increase in number with a change to the threshold by the user, the objects (“added objects”) which are newly added due to the change to the threshold are given priority in selecting.

The added object will be specifically described in the following.

Suppose, for example, the user has changed the parameter to which the key assignment control section 23 will make a reference from “D: 3.4” to “E: 2.2” in the list of FIG. 13. The selection of a lower importance threshold relaxes the conditions; objects which did not satisfy the old conditions and thus were not involved in a key assignment are not involved as candidates for a selection object. Specifically, the “added objects” added due to a change to the threshold refer to the objects having an importance value of 2.2 or greater and less than 3.4.

As the user makes the change to the threshold, the key assignment control section 23 identifies only the added objects having an importance value of 2.2 or greater and less than 3.4 as key assignment targets. Thereafter, if the LEFT and RIGHT keys are pressed, the key assignment control section 23 identifies a selection object from the added objects based on X coordinate values.

From the fact that the user enters a command to reduce the importance threshold and thus relax the conditions as above, it would be safe to presume that the objects desired by the user are not extracted (or not recognized as targets in the key assignment) and the user cannot select a target object. Therefore, the user is very likely to find a target object in the added objects which are selectable due to the relaxing of the conditions.

Accordingly, the key assignment control section 23 carries out a key assignment in accordance with assignment rule 12 so that the added objects are given high priority in the selection. The user are more likely to efficiently select a target object with fewer key strokes. As a result, user operability improves.

The following will describe in detail by way of concrete examples a procedure in which the key assignment control section 23 determines an order (assignment order) of assigning the LEFT and RIGHT keys so that the added objects are given priority in the selection. The following description assumes that the key assignment control section 23 operates in accordance with extraction rules R. The information on the assignment order determined by the key assignment control section 23 in accordance with extraction rules R is stored to the assignment order storage section 44 shown in FIG. 1.

### Extraction Rules R

UP Key: Select an immediately higher class of importance.
DOWN Key: Select an immediately lower class of importance.
LEFT Key: Select sequentially the objects located to the left of a reference object and belonging to importance class “n” or a higher class in ascending order of difference in X coordinate value from the reference object.
RIGHT Key: Select sequentially the objects located to the right of a reference object and belonging to importance class “n” or a higher class in ascending order of difference in X coordinate value from the reference object.

Current Parameter “n”(Importance Class)=8

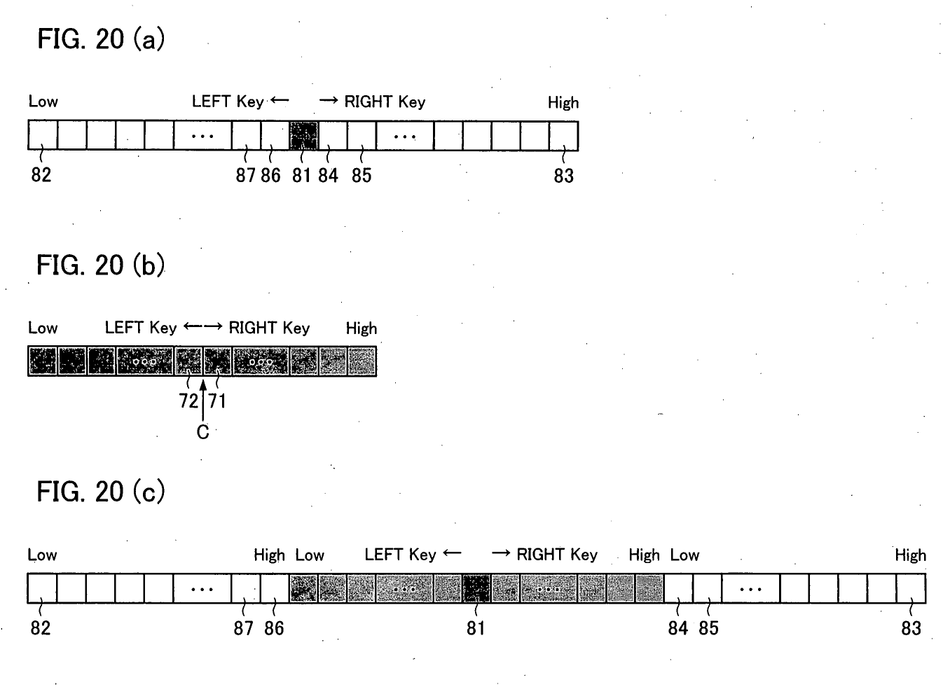

FIGS. 20(a) to 20(c) are diagrams illustrating data structures of information representing an assignment order of objects (locale information) determined by the key assignment control section 23 and stored in the assignment order storage section 44. FIGS. 20(a) to 20(c) explain modifications to the ranks of the objects to which the LEFT and RIGHT keys are assigned, on the basis of X coordinate values and the information as to whether or not the objects are the added objects added due to a change to a threshold.

FIG. 20(a) is a diagram illustrating a data structure obtained by the key assignment control section 23 sorting, by X coordinate value, sets of locale information belonging to importance class 8 or a higher class in accordance with extraction rules R. Each square represents one set of locale information. The middle square 81 represents the locale information of a selection object being currently selected. Since the squares (sets of locale information) are sorted by X coordinate ranking (FIG. 11), the square 82 (locale information) located at the leftmost end represents a set of locale information which has the lowest X coordinate rank (specifically, the set of locale information will be displayed on the far left of the display section 16). The square 83 located at the rightmost end represents a set of locale information which has the highest X coordinate rank (the set of locale information will be displayed on the far right of the display section 16).

As mentioned above, extraction rules R define a sequential selection starting with an object located nearest to a reference locale (square 81) in terms of difference in X coordinate value. Therefore, squares are sequentially selected starting with the square near the square 81 using the LEFT and RIGHT keys. The layout of the squares by itself (how close to the square 81) represents the order of selection.

Specifically, if the RIGHT key is pressed while the locale information of the square 81 is being selected, the key assignment control section 23 sequentially selects balloons for locales in the order of square 84, square 85, . . . , and square 83 in accordance with extraction rules R. Meanwhile, if the LEFT key is pressed in the same state, the section 23 sequentially selects balloons in the order of square 86, square 87, . . . , and square 82.

Here, suppose that the user presses the DOWN key, entering a command to move to an immediately lower class. The parameter determining section 26 determines that the parameter “n” (importance class) is 7. Accordingly, the key assignment control section 23 carries out a key assignment with the threshold of the importance class lowered by one in accordance with extraction rules R′. In other words, the order of selection is determined by identifying locale information for the locales which are new selection object candidates due to the class adjustment so that the added objects are given priority in the selection.

FIG. 20(b) is a diagram illustrating a data structure obtained by the key assignment control section 23 identifying sets of locale information for the locales belonging to class 7 which are new selection object candidates due to the adjustment of the parameter and sorting the sets by X coordinate rank.

The set of locale information having a X coordinate value nearest to the X coordinate value C of the square 81 (squares 71 and 72) are located nearest to the X coordinate value C.

Next, the key assignment control section 23 determines the order of selecting locales belonging to class 7 or higher classes. In other words, the section 23 calculates a union of the set of locale information shown in FIG. 20(a) (hereinafter, the “set A”) and the set of locale information shown in FIG. 20(b) (hereinafter, the “set B”) and sort the union.

FIG. 20(c) is a diagram illustrating a data structure obtained by the key assignment control section 23 sorting sets of locale information belonging to importance class 7 or a higher class in accordance with extraction rules R′ and assignment rule 12.

The key assignment control section 23 first places set B sorted by X coordinate rank to the position nearest to the locale of the selection object (square 81). Subsequently, the section 23 places set A. The key assignment control section 23 places the squares, of set A, located to the left of the square 81 (squares 86, 87, . . . , and 82) to the left of set B in terms of X coordinate rank. Likewise, the section 23 places the squares located to the right of the square 81 (squares 84, 85, . . . , 83) to the right of set B in terms of X coordinate rank.

As above, the key assignment control section 23 carries out a key assignment so that the added objects belonging to class 7 is given priority in selection in response to a press of the LEFT and RIGHT keys. Accordingly, the sets of locale information (added objects) belonging to class 7 are given priority in the selection. The fact that user lowers the parameter from class 8 to class 7 probably indicates that the user wants to select locale information not included in class 8 and higher classes. Therefore, by sorting in such manner to give priority in selection to the added objects added as new selection candidates due to the lowering of the class to 7, the user is likely to be able to efficiently select a target object with fewer key strokes. As a result, user operability improves.

The selection criterion (for example, importance) for the UP and DOWN keys and the selection criterion (for example, X coordinate value) for the LEFT and RIGHT keys may be exchanged using a key other than the direction keys (for example, the color keys 93 in FIG. 3). When the selection criteria are exchanged as above, the key assignment control section 23 may carry out a key assignment so that objects are selected with priority being given to objects having attribute information close to the attribute information owned by a selection object which provides a reference.

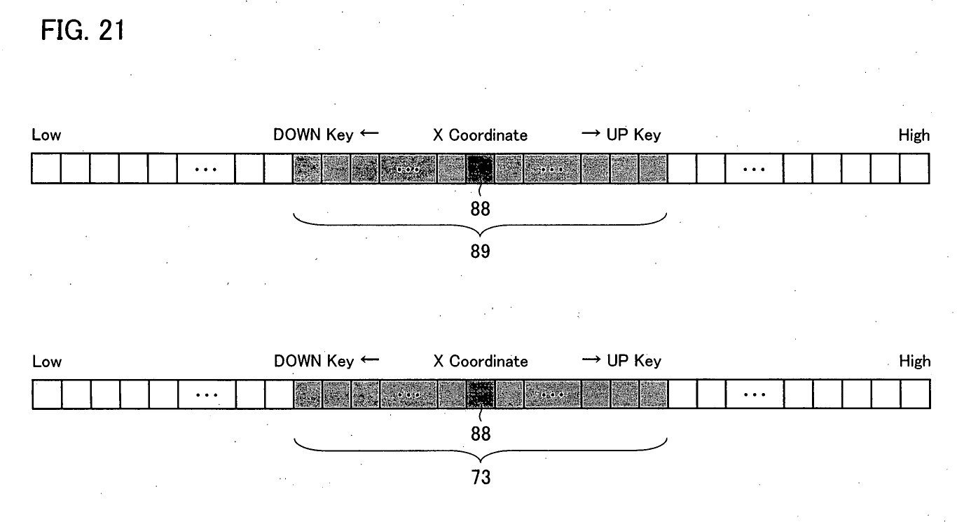

FIG. 21 is a diagram showing a data structure of an assignment order generated by the key assignment control section 23. The top half of the figure shows a data structure before switching a selection criterion for the assignment rule defined in association with the UP and DOWN keys from “importance” to “update date and time.” The bottom half shows a data structure after that switching.

Suppose that the square 88 indicates the reference locale (locale name: Sus-hi Lord America, importance class: 7, and update date and time class: 4) which is the current selection object. In the example shown in FIG. 21, the UP key is defined so that higher priority is given in selection to a locale which has an X coordinate value exceeding that of the reference locale and is located closer to the reference locale in terms of importance class and X coordinate value. Therefore, the locale information for the locale which satisfies these conditions better is placed closer to the square 88, or the reference locale.

For example, the group of squares 89 is a set of locales belonging to importance class 7 and the squares are sorted by X coordinate value.

When a key manipulation is carried out (for example, the red key is pressed by the user) to switch the selection criterion from “importance” to “update date and time” in that situation, the key assignment control section 23 switches the selection criterion from “importance” to “update date and time” and determines again the assignment order for the keys in association with locale information selected with the UP and DOWN keys (re-sorts the objects).

As shown in the bottom half of FIG. 21, the reference locale belongs to update date and time class 4. The key assignment control section 23 therefore sorts the set of squares 73 for locale information belonging to update date and time class 4 by X coordinate value and places the squares near the square 88.

Accordingly, the section 23 can carry out a key assignment so that if the selection criterion is switched, an object which has attribute information similar to the attribute information of the selection object currently being selected is selected before the others.

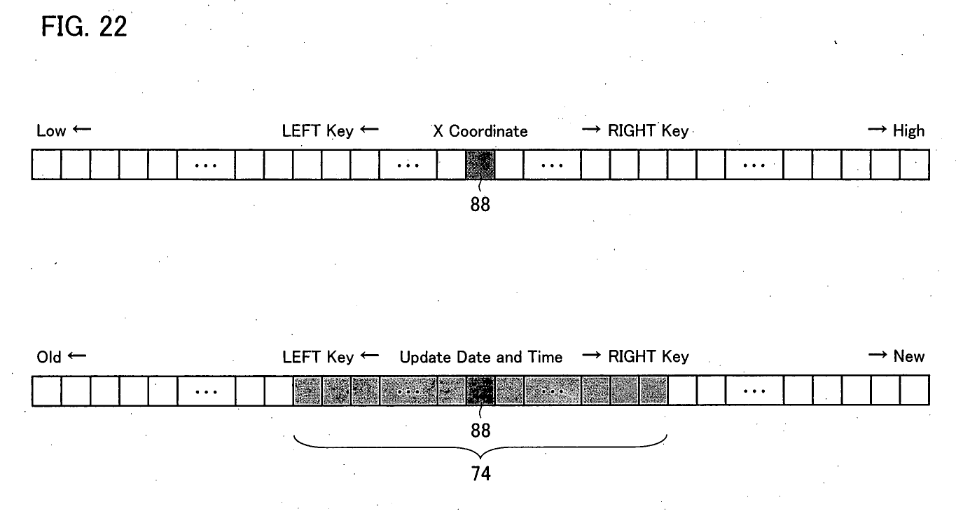

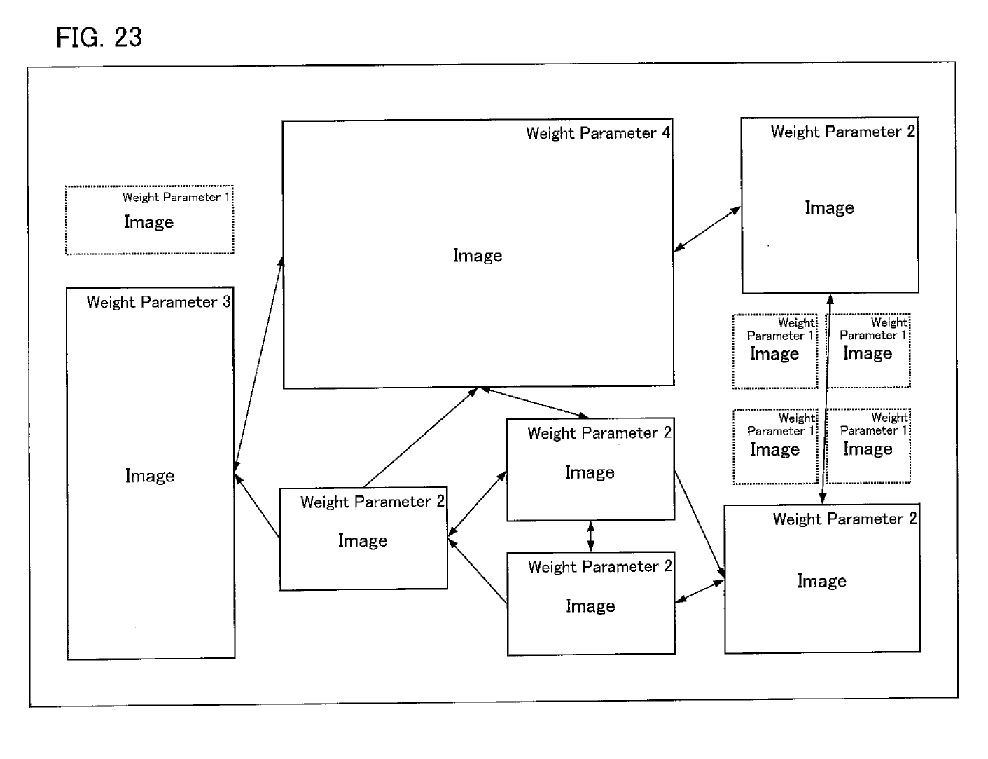

Furthermore, the key assignment control section 23 may carry out a key assignment in reference only to assignment rules 5 and 6, without considering the relative positions of objects. For example, if the rule followed by the key assignment control section 23 for the LEFT and RIGHT keys is switched from assignment rule 2 to assignment rule 6 shown in FIG. 8 by pressing a key other than the direction keys (ex. the blue key), the assignment order is determined again as shown in FIG. 22.

FIG. 22 shows in its top half the data structure of an assignment order in the case of sorting by X coordinate value before the blue key is pressed, and in its bottom half the data structure of an assignment order in the case of sorting by update date and time after the blue key is pressed.

As shown in FIG. 22, when sorting is done by update date and time class, a set (group of squares 74) having the same value as the update date and time class of the reference locale (square 88) is placed near the square 88.

As described in the foregoing, by assigning the selection criterion switching function to a key other than the direction keys, all the direction keys can be used to select objects, and the selection criterion used in that selection can be readily switched.

Even if the selection criterion is switched, the key assignment control section 23 carries out a key assignment so that priority is given in selection to objects which have similar values to the attribute information (importance, update date and time, etc.) of the selection object currently being selected. Specifically, objects which have a similar attribute to the current selection object are selected before others.

The object which the user wants to select next is likely to be found in the objects which have a similar attribute to the selection object selected by the user himself. As discussed so far, the user can efficiently select a target object with fewer key strokes.

In the present embodiment, the selection objects which the key assignment control section 23 assigns to keys have so far been limited to those displayed on the display section 16. This is by no means intended to be limiting the invention. The section 23 can assign objects not displayed on the display section 16 to keys provided that the object information storage section 40 stores the attribute information of those objects.

### Variation Example

Taking as an example the present invention being applied to the map display functionality of the digital television 1, the aforementioned embodiment has so far discussed cases of selecting balloons representing locales (and their locale information) on map information as objects.

However, the object extraction process and key assigning process of the present invention executed by the digital television 1 may be applied, without being limited to the examples, to cases of executing a random thumbnail display function. The random thumbnail display function is a function to present thumbnail images of different display sizes and shapes arranged to users in an irregular (randomly) rather than displaying thumbnail images of the same display size arranged in a conventional, regular manner. The random thumbnail display function is not limited to a function of randomly displaying photographic images. For example, the digital television 1 may display advertisements, newspaper articles, etc. downloaded from an external device over the Internet as objects of different sizes and shapes so that the user can select from them.

In the present embodiment, the digital television 1 can send a request to the album managing server 3 for photographs in an album uploaded to the network album DB131.

The digital television 1 then can display photographs downloaded from the album managing server 3 using the random thumbnail function on the display section 16. The user can select a photograph to be scaled up from the plurality of randomly displayed thumbnail photographs (objects) using the direction keys 91.

FIG. 23 is an exemplary random thumbnail display of a plurality of photographs on the display section 16.

User operability improves when the user selects a target thumbnail images by executing the object extraction process and key assigning process of the present invention even if the objects are thumbnail images (photographs) irregularly displayed in this manner.

For example, each photograph has information associated with it, such as the resolution, image size, display size, shooting date and time, and aspect ratio, as its attribute information. These pieces of attribute information, the display position of each photograph, etc. can be used as selection criteria.

More specifically, the key assignment control section 23 may carry out a key assignment so that photographs are sequentially selected in descending order of image size (or display size).

Image size is information on the size of photographic data and expressed in horizontal pixel count times vertical pixel count. Display size is information on the physical area occupied by the photograph when displayed on the display section 16. In other words, display size is layout information by which the image processing section 22 is instructed as to in what size the photograph should be displayed.

In addition, the object extraction section 21 may extract photographs for display so that only photographs taken on or after a certain shooting date and time are displayed. As shown in FIG. 23, the photographs not extracted may be displayed in pale colors to let the user know that they are not selectable.

Furthermore, the statistical processing section 25 may perform a statistical process on the attribute information of all the photographs mentioned above. In addition, the section 25 calculate a suitable weight parameter from all the attribute information. The parameter determining section 26 is capable of determining a suitable parameter (threshold) for use with extraction rules and assignment rules in accordance with results of the statistical process performed by the statistical processing section 25.

As discussed above, object extraction and key assignment can be done on not only locales and other like objects, but on two-dimensional objects like the thumbnail images above, based on relative positions and attribute information (display size, aspect ratio, etc.).

### Embodiment 2

The foregoing embodiment described cases where it is the digital television 1 itself that performs extraction and key assignment on the objects displayed on the display section 16 of the digital television 1. However, the invention is by no means limited to these examples.

For example, a server providing information displayed on the digital television 1 (the map service providing server 2, album managing server 3, etc. in FIG. 2) may execute the object extraction and key assignment and control object selecting operations by the digital television 1.

Accordingly, the structure needed to execute the object extraction and key assignment is provided only to the server (map service providing server 2, album managing server 3). An information display system can be built which allows simplification of the structure of the digital television 1 as a client and which nonetheless produces similar effects to the aforementioned embodiment.

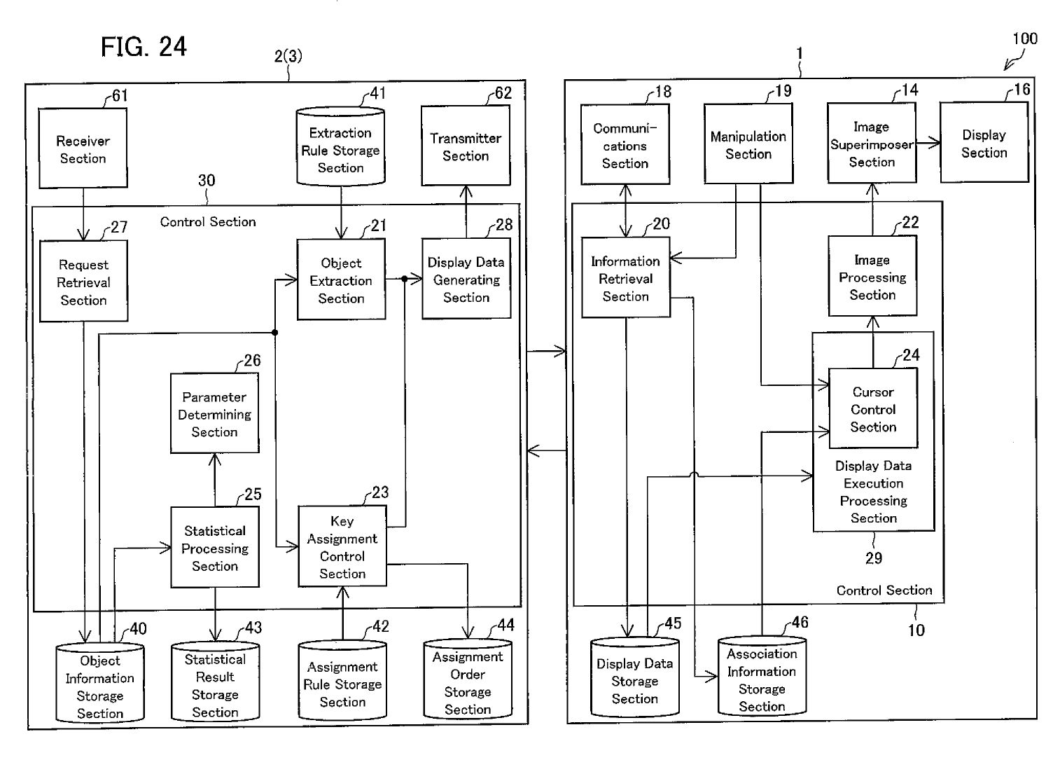

FIG. 24 is a diagram illustrating the configuration of major parts of devices in an information display system 100 of an embodiment of the present invention. As shown in FIG. 24, the information display system 100 includes the digital television 1 and either the map service providing server 2 or the album managing server 3 (hereinafter, only the map service providing server 2 will be described). The devices are connected over a communications network so that they can communicate with each other.

The map service providing server 2 includes the memories of the storage section 17, the object extraction section 21, the key assignment control section 23, the statistical processing section 25, and the parameter determining section 26 shown in FIG. 1.

The map service providing server 2 further includes a display data generating section 28, in place of the image processing section 22, for generating information (display data) for display on the digital television 1.

Display data specifically contains image data (for example, map data and balloon images superimposed on the map, locale information, or photographic images for a thumbnail display) for display on the display section 16 in the digital television 1 and control scripts instructing the digital television 1 which operation to perform in accordance with manipulation by the user.

The control scripts may be text written in, for example, XML (eXtensible Markup Language) and have advantages that their content can be readily modified and added before being fed to the digital television 1.

First, the request retrieval section 27 in the map service providing server 2 receives, from the digital television 1, a request message for the display data (map information) received by the receiver section 61. For example, the digital television 1 sends a request message containing the central latitude (N 45.59.03.143), central longitude (W 122.32.30.256), scale (1/25000), search target (restaurants), number of classes (10), screen vertical resolution (1024), and screen horizontal resolution (768).

The map service providing server 2 generates display data for display of map information of an area in accordance with the request message received from the digital television 1. Specifically, the object extraction section 21 extracts objects which should be contained in the display data (which should be displayed on the display section 16) from the object information storage section 40 in accordance with the extraction rules stored in the extraction rule storage section 41. Furthermore, the key assignment control section (information generating means) 23 associates the direction keys with objects to be selected when the direction keys are pressed in accordance with the assignment rules stored in the assignment rule storage section 42. In other words, the section 23 generates association information showing the relationship between the direction keys and the objects selected in response to a press of the keys.

Based on the association information generated by the key assignment control section 23, the display data generating section 28 generates control scripts containing association information instructing the digital television 1 as to which object should be selected when which direction key is pressed. The display data generating section 28 generates the display data containing image data (map data, thumbnail display data, etc.) for display of the objects, as well as the control scripts.

Finally, the transmitter section (supplying means) 62 in the map service providing server 2 transmits, as a response to the request message from the digital television 1, the display data to the digital television 1 over the Internet or other communications networks.

As shown in FIG. 24, in the information display system 100 of the present embodiment, the digital television 1 includes: an information retrieval section (information retrieval means) 20 for receiving display data from a map service providing server 2; a display data execution processing section 29 for executing control scripts for the display data (more specifically, a cursor control section, or object selecting section, 24 operating so as to select a suitable object in response to an input through direction keys in accordance with association information stored in an association information storage section 46); and an image processing section 22 for generating images so as to display the display data processed by the display data execution processing section 29 on the display section 16.

First, the information retrieval section 20 sends a request message for map information to the map service providing server 2 and receives display data as a response to the request from the map service providing server 2. The display data received by the information retrieval section 20 is stored to a display data storage section 45. The association information contained in the display data (or received separately from the display data) is stored to the association information storage section 46.

The display data execution processing section 29 displays the map data and balloons (objects) on the display section 16 based on the control scripts contained in the display data received from the map service providing server 2. When an object selection command signal is entered through the direction keys 91 on the manipulation section 19, the cursor control section 24 selects objects corresponding to the direction keys as specified by the association information stored in the association information storage section 46.

Accordingly, the digital television 1 is capable of reducing the number of objects displayed on the display section 16 by selectively displaying only objects which are likely to be selected by the user in accordance with the control scripts. Accordingly, the user can select a desired object with fewer key strokes.

The association information contained in the control scripts shows correspondence between keys and objects assigned to the keys in descending order of likelihood of being desired by the user. The correspondence is predetermined by the map service providing server 2 by considering attribute information of objects in addition to the directions of the direction keys and the relative positions of the objects.

Accordingly, the cursor control section 24 in the digital television 1 is capable of selecting objects which are likely to be desired by the user, in response with inputs using the direction keys in accordance with the association information.

From the foregoing, an information display system 100 is realized which delivers improved user operability by enabling efficient selection of a target object.

The map service providing server 2 may determine extraction rules (assignment rules) for reference or determine thresholds, by considering the content of the request message for display data from the digital television 1. For example, as mentioned earlier, the digital television 1 may include the central latitude (N 45.59.03.143), central longitude (W 122.32.30.256), scale (1/25000), search target (restaurants), number of classes (10), screen vertical resolution (1024), and screen horizontal resolution (768) in the request message for display data (map information) which is sent to the map service providing server 2. The map service providing server 2 is capable of determining a suitable number of objects to be extracted in accordance with the resolution of the digital television 1 at which the request originated. The server 2 is also capable of extracting only objects of specific types and carrying out a key assignment. The server 2 is also capable of determining suitable thresholds to create a specified number of classes based on results of a statistical process.

The display data execution processing section 29 in the digital television 1 in the present embodiment may include an object extraction section 21 to extract some of the objects received from the map service providing server 2 in accordance with the control scripts for the display data. Specifically, the digital television 1 receives, from the map service providing server 2, display data containing objects, the attribute information of the objects, and control scripts specifying object extraction based on the attribute information in accordance with manipulation by the user.

Accordingly, when instructed to execute an object extraction in accordance with the control scripts from the user, the object extraction section 21 is capable of extracting suitable objects using the attribute information.

The association information may be transmitted in the control scripts for display data as mentioned earlier or separately from the display data.

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the digital television 1 (taken here as an example encompassing the map service providing server 2 and the album managing server 3; the following description about the digital television 1 is also applicable to the servers 2, 3), especially, the object extraction section 21 and the key assignment control section 23, may be realized by hardware or software executed by a CPU as follows:

The digital television 1 includes a CPU (central processing unit) and memory devices (recording media). The CPU executes instructions contained in control programs, realizing functions. The memory devices may be a ROM (read-only memory) which contains programs, a RAM (random access memory) to which the programs are loaded, or a memory containing the programs and various data. The objective of the present invention can be achieved also by mounting to the digital television 1 a computer-readable recording medium containing control program code (executable programs, intermediate code programs, or source programs) for the digital television 1 which is software realizing the aforementioned functions, in order for the computer (or CPU, MPU) to retrieve and execute the program code contained in the recording medium.

The recording medium may be, for example, a tape, such as a magnetic tape or a cassette tape; a magnetic disk, such as a Floppy® disk or a hard disk, or an optical disc, such as CD-ROM/MO/MD/DVD/CD-R; a card, such as an IC card (memory card) or an optical card; or a semiconductor memory, such as a mask ROM/EPROM/EEPROM/flash ROM.

The digital television 1 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, electric power line, cable TV line, telephone line, or ADSL; or wireless, such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically.

### Supplement

The information display apparatus, in addition to the foregoing configuration, preferably further includes an extraction section for comparing the one or more attribute values of each object with a threshold(s) of the attribute(s) and extracting objects which meet predetermined conditions in the comparison as objects which the key assignment section can assign to the direction keys.

According to the configuration, the extraction section compares the one or more attribute values of each object with a threshold(s) of the attribute(s). Different thresholds may be predetermined for different types of attributes.

Only if the comparison of the attribute value of an object with a threshold indicates that the object meets the predetermined conditions, the extraction section extracts the object having the attribute value as an object which the key assignment section can assign to a key.

Specifically, the objects assigned to the direction keys may be limited only to objects of which the attribute values meet predetermined conditions.

Accordingly, the display section can display a reduced number of candidates for objects to be selected and receives a selection by the user.

The user has only to manipulate the direction keys to select a target object from a reduced number of objects. The user can thus efficiently select the target object with fewer key strokes.

The predetermined conditions are information used by the extraction section in determining in accordance with a result of the comparison of the attribute value of an object to the threshold whether or not the object should be extracted. The conditions are included in the information on which objects should be extracted and assigned to keys, or more specifically, in an extraction rule defining an object extraction method.

For example, the extraction rule “extract objects with importance equal to n or higher” includes a condition “importance equal to n or higher.” Here, n is a threshold. The extraction section compares the importance of the objects with the importance threshold n and extracts, as objects to be assigned to keys, only objects with importance equal to or higher than the threshold n.

Objects with importance below n are not considered important and therefore unlikely to be selected by the user. By filtering out objects which are unlikely to be selected by the user in this manner, the number of objects displayed on the display section is reduced.

The user can efficiently select the target object from even fewer, but likely-to-be-selected objects.

Preferably, the ranking section ranks the objects by an attribute value for a first attribute; the key assignment section assigns the objects to one or some of the direction keys sequentially as ranked by the ranking section by the attribute value for the first attribute; the ranking section ranks the objects by an attribute value for a second attribute; and the key assignment section assigns the objects to direction keys other than the one or some of the direction keys sequentially as ranked by the ranking section by the attribute value for the second attribute.

According to the configuration, the key assignment section assigns the objects to the one or some of the direction keys according to the ranking by the attribute value for the first attribute and to direction keys other than the one or some of the direction keys according to the ranking by the attribute value for the second attribute.

Hence, the user can easily switch between a mode in which objects are selected in reference to the first attribute and a mode in which objects are selected in reference to the second attribute by simply using the two sets of direction keys for different purposes.

Accordingly, the user can efficiently select the target object and as a result enjoy improved user operability.

A concrete example for an input device equipped with four direction keys (UP, DOWN, LEFT, and RIGHT) is to designate the UP and DOWN keys as the one or some of the direction keys and the LEFT and RIGHT keys as the direction keys other than the one or some of the direction keys.

The key assignment section then assigns, if the objects are to be selected using the UP and DOWN keys, the objects to the UP and DOWN keys sequentially so that the objects are selected according to the X coordinate values of the display positions (attribute values of the first attribute) and assigns, if the objects are to be selected using the LEFT and RIGHT keys, the objects to the LEFT and RIGHT keys so that the objects are selected in descending order of importance (attribute values of the second attribute).

Accordingly, the user easily switch between desired selection criteria by using the UP and DOWN keys and the LEFT and RIGHT keys in different manners. The user can more efficiently select the target object and as a result, enjoy improved user operability.

Alternatively, the key assignment section may assign a function of switching attributes by which the ranking section ranks the objects to a direction key other than the direction keys to which the key assignment section assigns the objects.

Accordingly, when the user wants to select an object using the direction keys to which the key assignment section assigns the objects, the user can easily switch selection criteria by manipulating a direction key(s) other than the direction keys to which the key assignment section assigns the objects. Therefore, the user can more efficiently select the target object and as a result, enjoy improved user operability.

Alternatively, the key assignment section may assign a function of changing a threshold of an attribute value used by the extraction section in the extraction of objects to a direction key other than the direction keys to which the key assignment section assigns the objects.

Accordingly, the user can easily change the threshold of the attribute value referenced when the extraction section extracts objects displayed on the display section (objects which the key assignment section can assign to the direction keys), by manipulating a direction key(s) other than the direction keys to which the key assignment section assigns the objects.

Therefore, the user can easily extract objects using a desired threshold. The user can more efficiently select the target object and as a result, enjoy improved user operability.

The information display apparatus preferably further includes attribute value identifying section for identifying an attribute value for an object has a rank selected by a user from the ranking determined by the ranking section.

According to the configuration, when ranks are selected from the ranking of the objects as a result of the user specifying desirable ranks or in response to a predetermined rank setup, the attribute value identifying section identifies objects in the order of the selection and retrieves the attribute values of the objects.

Accordingly, a threshold can be identified to reduce the number of objects in accordance with a desired number of objects extracted.

In other words, the attribute value identified based on the predetermined ranks can be used straight away as a threshold. The rank of an object is a total count of objects which have an attribute value greater than or equal to the attribute value of that object.

Therefore, for example, if the user wants to extracted 100 objects, he should specify the 100th rank. The attribute value identifying section references an association table (see FIG. 11 for an example) in which the objects, ranks, and attribute values are associated and identifies the attribute value of the 100th object sequentially in the order of selection.

Here, by designating the attribute value identified by the attribute value identifying section as the threshold, the extraction section can extract up to 100 objects.

As described in the foregoing, a threshold can be identified for use in reducing the number of extracted objects in accordance with the desired number of extracted objects. The user can adjust the number of displayed objects and thus enjoy improved user operability.

The information display apparatus preferably further includes extraction section for determining the number of objects to be displayed on the display section in accordance with specifications of the display section and extracting the determined number of objects from the objects sequentially as ranked by the ranking section as objects which the key assignment section can assign to the direction keys.

According to the configuration, the number of objects to be displayed is determined in accordance with the specifications (screen size, resolution, etc.) of the display section.

Accordingly, the objects can be displayed so that the user can easily recognize the displayed objects.

For example, if a lot of selectable objects are displayed without considering the screen size or resolution, the user may have trouble in visually recognizing the individual objects or the currently selected object.

According to the configuration, the number of objects to be displayed is determined in accordance with the specifications of the display section so as to reduce the displayed objects. The user interface becomes easier to navigate for the user.

The information display apparatus of the invention and the information providing server of the invention may be realized on a computer. In that case, the invention encompasses a control program, for the information display apparatus or the information providing server, for causing a computer to operate as each of the sections so as to realize the information display apparatus or the information providing server on the computer. The invention also encompasses a computer-readable recording medium containing the program.

The information display apparatus of the invention and the information providing server of the invention are widely applicable to general information display apparatuses which display a plurality of objects on a display so that the user can select from the objects and which receives selections of objects from the user via an input device. The invention is also applicable to various server devices which provides digital televisions and like information display apparatuses with control scripts by which information display operation by the digital television is controlled.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed is:

1. An information display apparatus for displaying on a display section a plurality of objects from which a user can select one of the objects by manipulating one or more direction keys so as to instruct a cursor to move in a specified direction and point to that object to be selected, said apparatus including an object information storage section containing one or more numerical attribute values indicative of an attribute(s) of each object in association with that object, said apparatus comprising:
ranking means for ranking the objects by the one or more attribute values in accordance with a predetermined rule; and
key assignment means for assigning the objects to the direction keys sequentially as ranked by the ranking means.

2. The information display apparatus of claim 1, further comprising extraction means for comparing the one or more attribute values of each object with a threshold(s) of the attribute(s) and extracting objects which meet predetermined conditions in the comparison as objects which the key assignment means can assign to the direction keys.

3. The information display apparatus of claim 1, wherein:
the ranking means ranks the objects by an attribute value for a first attribute;
the key assignment means assigns the objects to one or some of the direction keys sequentially as ranked by the ranking means by the attribute value for the first attribute;
the ranking means ranks the objects by an attribute value for a second attribute; and
the key assignment means assigns the objects to direction keys other than the one or some of the direction keys sequentially as ranked by the ranking means by the attribute value for the second attribute.

4. The information display apparatus of claim 1, wherein the key assignment means assigns a function of switching attributes by which the ranking means ranks the objects to a direction key other than the direction keys to which the key assignment means assigns the objects.

5. The information display apparatus of claim 2, wherein the key assignment means assigns a function of changing a threshold of an attribute value used by the extraction means in the extraction of objects to a direction key other than the direction keys to which the key assignment means assigns the objects.

6. The information display apparatus of claim 2, further comprising attribute value identifying means for identifying an attribute value for an object has a rank selected by a user from the ranking determined by the ranking means.

7. The information display apparatus of claim 1, further comprising extraction means for determining the number of objects to be displayed on the display section in accordance with specifications of the display section and extracting the determined number of objects from the objects sequentially as ranked by the ranking means as objects which the key assignment means can assign to the direction keys.

8. An information providing server for supplying, to an information display apparatus, display data used to display on a display section a plurality of objects from which a user can select one of the objects by manipulating one or more direction keys so as to instruct a cursor to move in a specified direction and point to that object to be selected, said server including an object information storage section containing one or more numerical attribute values indicative of an attributes of each object in association with that object, said server comprising:
ranking means for ranking the objects by the one or more attribute values in accordance with a predetermined rule;
key assignment means for assigning the objects to the direction keys on the information display apparatus sequentially as ranked by the ranking means;
information generating means for generating association information indicative of correspondence between the objects and the direction keys in accordance with results of the assigning by the key assignment means; and
supplying means for supplying the association information to the information display apparatus.

9. An information display system, comprising: an information providing server and an information display apparatus,
said server being provided for supplying, to the information display apparatus, display data used to display on a display section a plurality of objects from which a user can select one of the objects by manipulating one or more direction keys so as to instruct a cursor to move in a specified direction and point to that object to be selected,
said server including an object information storage section containing one or more numerical attribute values indicative of an attributes of each object in association with that object, said server including: ranking means for ranking the objects by the one or more attribute values in accordance with a predetermined rule; key assignment means for assigning the objects to the direction keys on the information display apparatus sequentially as ranked by the ranking means; information generating means for generating association information indicative of correspondence between the objects and the direction keys in accordance with results of the assigning by the key assignment means; and supplying means for supplying the association information to the information display apparatus,
said information display apparatus including: information retrieval means for retrieving display data and association information, the display data being used to display on a display section a plurality of objects from which a user can select one of the objects by manipulating one or more direction keys so as to instruct a cursor to move in a specified direction and point to that object to be selected, the association information being indicative of correspondence between the objects and the direction keys; and object selecting means for, when one of the direction keys is manipulated while the objects are being displayed on the display section in accordance with the display data, moving the cursor to an object assigned to the manipulated key in accordance with the association information so as to select that object.

10. A method for controlling an information display apparatus for displaying on a display section a plurality of objects from which a user can select one of the objects by manipulating one or more direction keys so as to instruct a cursor to move in a specified direction and point to that object to be selected, said method comprising the steps of:
(a) ranking, in accordance with a predetermined rule, the objects by one or more numerical attribute values, contained in an object information storage section, indicative of an attribute(s) of each object in association with that object; and
(b) assigning the objects to the direction keys sequentially as ranked in step (a).

11. A method for controlling an information providing server for supplying, to an information display apparatus, display data used to display on a display section a plurality of objects from which a user can select one of the objects by manipulating one or more direction keys so as to instruct a cursor to move in a specified direction and point to that object to be selected, said method comprising the steps of:
(a) ranking, in accordance with a predetermined rule, the objects by one or more numerical attribute values, contained in an object information storage section, indicative of an attribute(s) of each object in association with that object;
(b) assigning the objects to the direction keys on the information display apparatus sequentially as ranked in step (a);
(c) generating association information indicative of correspondence between the objects and the direction keys in accordance with results of the assigning in step (b); and
(d) supplying the association information to the information display apparatus.

12. A computer-readable recording medium containing a control program for controlling an information display apparatus for displaying on a display section a plurality of objects from which a user can select one of the objects by manipulating one or more direction keys so as to instruct a cursor to move in a specified direction and point to that object to be selected, said program causing a computer to implement the steps of:
(a) ranking, in accordance with a predetermined rule, the objects by one or more numerical attribute values, contained in an object information storage section, indicative of an attributers) of each object in association with that object; and
(b) assigning the objects to the direction keys sequentially as ranked in step (a).

13. A computer-readable recording medium containing a control program for controlling an information providing server for supplying, to an information display apparatus, display data used to display on a display section a plurality of objects from which a user can select one of the objects by manipulating one or more direction keys so as to instruct a cursor to move in a specified direction and point to that object to be selected, said program causing a computer to implement the steps of:
(a) ranking, in accordance with a predetermined rule, the objects by one or more numerical attribute values, contained in an object information storage section, indicative of an attribute(s) of each object in association with that object;
(b) assigning the objects to the direction keys on the information display apparatus sequentially as ranked in step (a);
(c) generating association information indicative of correspondence between the objects and the direction keys in accordance with results of the assigning in step (b); and
(d) supplying the association information to the information display apparatus.
